(19) United States
(12) Patent Application Publication
(10) Pub. No.: US 2024/0021798 A1
(43) Pub. Date: Jan. 18, 2024

(54) SILICON ANODE MULTILAYER FOR ELECTROCHEMICAL CELLS

(71) Applicant: Solid Power Operating, Inc., Louisville, CO (US)

(72) Inventors: Rose E. RUTHER, Lafayette, CO (US); Kristen T. HIETALA, Boulder, CO (US); Steven MADACHY, Broomfield, CO (US)

(21) Appl. No.: 18/222,326

(22) Filed: Jul. 14, 2023

Related U.S. Application Data
(60) Provisional application No. 63/389,701, filed on Jul. 15, 2022.

(51) Int. Cl. H01M 4/36; H01M 4/38; H01M 4/62; H01M 10/0562; H01M 4/134; H01M 4/1395; H01M 4/04

(52) U.S. Cl. CPC H01M 4/366; H01M 4/386; H01M 4/622; H01M 10/0562; H01M 4/134; H01M 4/625; H01M 4/1395; H01M 4/0404; H01M 2004/027

(57) ABSTRACT

Provided herein is a negative electrode or anode for an electrochemical cell having two or more layers. Each layer may include different concentrations of an anode active material to provide improved electrical and physical qualities as compared to a mono-layer anode.

### CROSS-REFERENCE TO RELATED APPLICATION

This application is related to and claims priority under 35 U.S.C. § 119(e) from U.S. Patent Application No. 63/389,701 filed Jul. 15, 2022, entitled “Silicon Anode Multilayer for Electrochemical Cells,” the entire contents of which is incorporated herein by reference for all purposes.

### TECHNICAL FIELD

Various embodiments described herein relate to the field of solid-electrolyte-containing primary and secondary electrochemical cells, electrodes, and electrode materials, and the corresponding methods of making and using the same.

### BACKGROUND

Lithium-based rechargeable batteries are popular to power many forms of modern electronics and have the capability to serve as the power source for hybrid and fully electric vehicles. State-of-the-art lithium-based rechargeable batteries typically employ a carbon-based anode to store lithium ions. In these anodes, lithium ions are stored by intercalating between planes of carbon atoms that compose graphite particles. Carbon-based anodes have been tailored to confer acceptable performance in modern lithium-ion batteries. However, carbon-based anodes are reaching maturity in terms of their lithium-ion storage.

An alternative to the carbon-based anode is an alloy-type anode. In the alloy-type anode, rather than intercalating between sheets of carbon in graphite particles, the lithium ions alloy with the active anode material. These materials may have up to ten times (10x) more lithium-ion storage capacity as compared to that of graphite anodes. The typical alloy-type anodes include silicon, tin, and aluminum, as well as more exotic materials, such as germanium and gold. These alloy materials have their own advantages and disadvantages, such as cost, specific capacity, processability, and voltage penalty.

One of the challenges to confront in these systems is the volume change associated with alloying lithium with the active material. For example, volume changes near 400% can happen with some systems. The volume change can cause difficulties from a macro and micro level. At the macro level, a battery pack may have to accommodate a swelling cell, and at the micro level, the continuous expansion and contraction of the active area can lead to cracking. The particles in the active area then can lose electrical connection with their surrounding matrix and can also undergo undesirable side reactions between the fresh surfaces of the particles and the battery electrolyte.

Silicon (Si) is one example of an alloy-type anode material, which theoretically can store more than ten times the amount of lithium ions as compared to graphite, has a modest voltage penalty, and in its bulk form is abundant and inexpensive. Unfortunately, in conventional liquid electrolyte lithium-ion cells, the large (e.g., 400%) volume change of silicon-lithium alloys has frustrated efforts to employ silicon in the anode. As the material expands and contracts, cracking occurs and the fresh surfaces of the cracks that are exposed react to form a new solid electrolyte interphase, which consumes electrolyte and the supply of lithium in the cell. Therefore, the cell loses a portion of its capacity during each cycle and may ultimately fail after some numbers of cycles.

Not many solutions exist to remediate the problem of volume expansion. The most common solution is simply to reduce the amount of active material in the anode, which results in less volume expansion and contraction. However, this also results in poorer performance of the electrochemical cell, including reducing the capacity of the cell. Liquid electrolytes have also been used to maintain contact between the anode and the electrolyte, but solid-state electrolytes are generally safer and have higher thermal stability than liquid electrolytes.

What is needed is an anode that provides improved cell performance and maintains interfacial contact with an electrolyte layer.

### SUMMARY

Provided herein is an anode composition. The composition comprises a first anode layer in operable contact with a second anode layer. The first anode layer and the second anode layer each comprise an anode active material, a binder, a conductive additive, and optionally a solid-state electrolyte material. In some embodiments, the second anode layer comprises a solid electrolyte material. The weight percent amount of the anode active material, binder, conductive additive, and/or solid-state electrolyte material in the first anode layer is different from the amount in the second anode layer. In exemplary embodiments, the first anode layer is in direct contact with the second anode layer.

In some embodiments, the anode active material is present in the first anode layer in an amount of greater than or equal to about 50% by weight of the first anode layer. In some embodiments, the anode active material is present in the second anode layer in an amount of about 20% to about 70% by weight of the second anode layer.

In some embodiments, the anode active material of the first anode layer is an inorganic material. In some aspects, the inorganic material is selected from the group consisting of silicon, silicon alloys, tin, tin alloys, germanium, germanium alloys, and combinations thereof. In exemplary embodiments, the inorganic material is silicon, silicon alloys, or combinations thereof. In further exemplary embodiments, the silicon or silicon alloy has a particle size of less than about 1 micron.

In some embodiments, the anode active material of the second anode layer is an inorganic material. In some aspects, the inorganic material is selected from the group consisting of silicon, silicon alloys, tin, tin alloys, germanium, germanium alloys, and combinations thereof. In exemplary embodiments, the inorganic material is silicon, silicon alloys, or combinations thereof. In further exemplary embodiments, the silicon or silicon alloy has a particle size of about 1 micron. In still further exemplary embodiments, the anode active material in the first anode layer is the same as the anode active material in the second anode layer. In even further exemplary embodiments, the anode active material in the first anode layer is different than the anode active material in the second anode layer.

In some embodiments, the conductive additive of the first anode layer comprises a carbon-based conductive additive. In some aspects, the carbon-based conductive additive is selected from the group consisting of graphite, graphene, carbon black, carbon nanotubes, carbon nanowires, vapor grown carbon fiber, activated carbon, and combinations thereof.

In some embodiments, the conductive additive of the second anode layer comprises a carbon-based conductive additive. In some aspects, the carbon-based conductive additive is selected from the group consisting of graphite, graphene, carbon black, carbon nanotubes, carbon nanowires, vapor grown carbon fiber, activated carbon, and combinations thereof.

In some embodiments, the second anode layer further comprises a tackifier. In some aspects, the tackifier comprises a hydrocarbon resin.

In some embodiments, the second layer further comprises a plasticizer. In some aspects, the plasticizer is dioctyl phthalate, dibutyl sebecate, mineral oil, or combinations thereof.

In some embodiments, the solid electrolyte material of the first layer is a sulfide electrolyte, an oxide electrolyte, an oxysulfide electrolyte, or a halide electrolyte. In some aspects, the particle size of the solid electrolyte material of the first layer is about 1 micron. In some embodiments, the first anode layer comprises substantially no solid electrolyte material, such as about 5% by weight or less of the first anode layer, or about 1% by weight or less of the first anode layer. In some aspects, the first anode layer may be devoid of a solid electrolyte material.

In some embodiments, the solid electrolyte material of the second layer is a sulfide electrolyte, an oxide electrolyte, an oxysulfide electrolyte, or a halide electrolyte. In some aspects, the particle size of the solid electrolyte material of the second layer is about 1 micron.

In some embodiments, the first anode layer has a thickness of about 70 microns prior to densification. In some additional embodiments, the second anode layer has a thickness of about 50 microns prior to densification. In some aspects, the first anode layer has a thickness that is about 40% greater than the thickness of the second anode layer.

In some embodiments, a stack pressure of about 1500 psi or less is applied to the composition. In some embodiments, the first anode layer comprises vertical cracks. In an exemplary embodiment, the first anode layer comprises vertical cracks as represented by FIG. 2. In some embodiments, the first anode layer comprises vertical cracks, but the second anode layer does not comprise vertical cracks. In some exemplary embodiments, the second anode layer does not exhibit cracking after a first cell cycle.

In some embodiments, the first anode layer has a porosity of about 25% to about 50%. In some additional embodiments, the second anode layer has a porosity of about 10% to about 50%.

In some preferred embodiments, the anode active material comprises silicon in an amount of about 50% to 98% by weight of the first anode layer, and wherein the anode active material comprises silicon in an amount of about 20% to about 50% by weight of the second anode layer. In some aspects, the anode active material comprises silicon in an amount of about 50% to about 70% by weight of the first anode layer, or more preferably about 60% to about 70% by weight of the first anode layer. In still further aspects, the anode active material comprises silicon in an amount of about 20% to about 40% by weight of the second anode layer, or more preferably about 30% by weight of the second anode layer.

In some embodiments, the composition contacts a current collector. In some embodiments, the composition contacts a separator layer.

In some embodiments, the composition comprises a third anode layer. The third anode layer comprises an anode active material, a binder, a conductive additive, and a solid electrolyte material. The amount of the anode active material, binder, conductive additive, and/or solid electrolyte material in the third anode layer may be different from the amounts in the first anode layer or the second anode layer.

Further provided herein is a composition comprising a bilayer anode. The bilayer anode comprises a first anode layer and a second anode layer. The first anode layer comprises a first anode active material, wherein the first anode active material is present in the first layer in an amount of greater than or equal to about 50% by weight of the first layer; a first binder, a first conductive additive; and optionally a first solid electrolyte material. The second anode layer comprises a second anode active material, wherein the second anode active material is present in the second layer in an amount of about 20% to about 50% by weight of the second layer; a second binder; a second conductive additive; and a second solid electrolyte material. In some exemplary embodiments, the first anode active material is the same as the second anode active material. In some additional exemplary embodiments, the first anode active material is different than the second anode active material.

In some embodiments, the first anode active material is an inorganic material. In some aspects, the inorganic material is selected from the group consisting of silicon, silicon alloys, tin, tin alloys, germanium, germanium alloys, and combinations thereof. In preferred embodiments, the inorganic material is silicon, silicon alloys, or combinations thereof. In further preferred embodiments, the silicon or silicon alloy has a particle size of less than about 1 micron.

In some embodiments, the second anode active material is an inorganic material. In some aspects, the inorganic material is selected from the group consisting of silicon, silicon alloys, tin, tin alloys, germanium, germanium alloys, and combinations thereof. In preferred embodiments, the inorganic material is silicon, silicon alloys, or combinations thereof. In further preferred embodiments, the silicon or silicon alloy has a particle size of about 1 micron.

In some embodiments, the first conductive additive comprises a carbon-based conductive additive. In some aspects, the carbon-based conductive additive is selected from the group consisting of graphite, graphene, carbon black, carbon nanotubes, carbon nanowires, vapor grown carbon fiber, activated carbon, and combinations thereof.

In some embodiments, the second conductive additive comprises a carbon-based conductive additive. In some aspects, the carbon-based conductive additive is selected from the group consisting of graphite, graphene, carbon black, carbon nanotubes, carbon nanowires, vapor grown carbon fiber, activated carbon, and combinations thereof.

In some embodiments, the second anode layer further comprises a tackifier. In some aspects, the tackifier comprises a hydrocarbon resin.

In some embodiments, wherein the second anode layer further comprises a plasticizer. In some aspects, the plasticizer is dioctyl phthalate, dibutyl sebecate, mineral oil, or combinations thereof.

In some embodiments, the first solid electrolyte material is a sulfide electrolyte, an oxide electrolyte, oxysulfide electrolyte, or a halide electrolyte. In some aspects, the particle size of the first solid electrolyte material is about 1 micron. In some embodiments, the second solid electrolyte material is a sulfide electrolyte, an oxide electrolyte, an oxysulfide electrolyte, or a halide electrolyte. In some aspects, the particle size of the second solid electrolyte material is about 1 micron. In some embodiments, the first anode layer comprises substantially no solid electrolyte material, such as about 5% by weight or less of the first anode layer, or about 1% by weight or less of the first anode layer. In some aspects, the first anode layer may be devoid of a solid electrolyte material.

In some embodiments, the first anode layer has a thickness of about 70 microns prior to densification. In some embodiments, the second anode layer has a thickness of about 50 microns prior to densification. In an exemplary embodiment, the first anode layer has a thickness that is about 40% greater than the thickness of the second anode layer.

In some embodiments, a stack pressure of about 1500 psi or less is applied to the composition. In some embodiments, the second anode layer does not exhibit cracking after a first cell cycle.

In some embodiments, the first anode layer has a porosity of about 25% to about 50%. In some embodiments, the second layer has a porosity of about 10% to about 50%.

In an exemplary embodiment, the first anode active material comprises silicon in an amount of about 50% to 98% by weight of the first anode layer, and wherein the second anode active material comprises silicon in an amount of about 20% to about 50% by weight of the second anode layer. In preferred embodiments, the first anode active material comprises silicon in an amount of about 50% to about 70% by weight of the first anode layer, or more preferably about 60% to about 70% by weight of the first anode layer. In preferred embodiments, the second anode active material comprises silicon in an amount of about 20% to about 40% by weight of the second anode layer, or more preferably about 30% by weight of the second layer.

In some embodiments, the anode bilayer contacts a current collector. In some embodiments, the anode bilayer contacts a separator layer.

In some embodiments, the first anode layer comprises vertical cracks. In some further embodiments, the first anode layer comprises vertical cracks, but the second anode layer does not comprise vertical cracks. In an exemplary embodiment, the first anode layer comprises vertical cracks as represented by FIG. 2.

Further provided herein is an anode composition. The solid anode composition comprises a first anode layer and a second anode layer. The first anode layer comprises an active material comprising silicon in an amount of about 60% or greater by weight of the first layer, a first binder in an amount of about 7% or less by weight of the first layer, a first conductive additive in an amount of about 5% or less by weight of the first layer, and a first solid electrolyte material in an amount of about 23% or less by weight of the first layer. The second layer comprises a second anode active material comprising silicon in an amount of about 30% by weight of the second layer, a second binder in an amount of about 6% by weight of the second layer, a second conductive additive in an amount of about 5% by weight of the second layer, a second solid electrolyte material in an amount of about 45% or less by weight of the second layer, a plasticizer in an amount of about 4% by weight of the second layer, and a tackifier in an amount of about 10% by weight of the second layer.

Further provided herein is an anode composition. The solid anode composition comprises a first anode layer and a second anode layer. The first anode layer comprises an active material comprising silicon in an amount of about 60% or greater by weight of the first layer, a first binder in an amount of about 7% or less by weight of the first layer, a first conductive additive in an amount of about 5% or less by weight of the first layer, and a first solid electrolyte material in an amount of about 23% or less by weight of the first layer. The second layer comprises a second anode active material comprising silicon in an amount of about 30% by weight of the second layer, a second binder in an amount of about 6% by weight of the second layer, a second conductive additive in an amount of about 5% by weight of the second layer, a second solid electrolyte material in an amount of about 45% or less by weight of the second layer, a plasticizer in an amount of about 4% by weight of the second layer, and a tackifier in an amount of about 10% by weight of the second layer.

Further provided herein is an anode composition. The anode composition comprises a first anode layer and a second anode layer. The first anode layer comprises an anode active material in an amount of about 60% or greater by weight of the first layer, a first binder in an amount of about 0% to about 20% by weight of the first layer, and a first solid electrolyte material in an amount of about 20% to about 30% by weight of the first layer. The second layer comprises a second anode active material in an amount of about 20% to about 50% by weight of the second layer, a second binder in an amount of about 10% or less by weight of the second layer, and a second solid electrolyte material in an amount of about 45% or less by weight of the second layer.

Further provided herein is an electrochemical cell comprising a bilayer anode of the present disclosure, a separator layer, and a cathode layer. The electrolyte within the layers of the electrochemical cell may be solid, semi-solid (e.g., a gel), and/or liquid. In a particular embodiment, the anode layer may be a solid-state anode layer.

In some embodiments, the electrochemical cell further comprises a first current collector disposed adjacent to the bilayer anode. In some aspects, the first current collector comprises copper, nickel, or stainless steel.

In some embodiments, the electrochemical cell has a higher specific discharge capacity compared to an electrochemical cell comprising a monolayer anode. In some embodiments, the discharge capacity of the cell is stable for a greater number of cycles as compared to an electrochemical cell comprising a monolayer anode. In an exemplary embodiment, the discharge capacity of the cell is stable for at least 100 cycles.

In some embodiments, the electrochemical cell has a lower internal resistance as compared to an electrochemical cell comprising a monolayer anode.

In some embodiments, the bilayer anode does not separate from the separator layer when the electrochemical cell is cycled at a stack pressure of less than 1500 psi.

In some embodiments, the bilayer anode has better surface area contact with the separator layer as compared to an electrochemical cell having a monolayer anode. In some embodiments, the surface area contact of the bilayer anode and the separator layer is determined by SEM imaging. In some embodiments, less void space is present between the bilayer anode and the separator layer as compared to an electrochemical cell having a monolayer anode.

Further provided herein is a method of making a bilayer anode composition. The method comprises a) forming a first anode slurry by mixing an anode active material, at least one solid electrolyte material, at least one binder material, and a solvent; b) forming a second anode layer slurry by: mixing an anode active material, at least one solid electrolyte material, at least one binder material, optionally at least one tackifier, optionally at least one plasticizer, and a solvent; c) casting the first anode layer slurry onto a substrate; d) casting the second anode layer slurry onto the first anode layer slurry; and e) drying the first anode layer slurry and the second anode layer slurry to form the anode bilayer.

Further provided herein is a method of making a bilayer anode composition. The method comprises a) forming a first anode layer slurry by: mixing an anode active material, optionally at least one solid electrolyte material, at least one binder material, and a solvent; b) forming a second anode layer slurry by: mixing an anode active material, at least one solid electrolyte material, at least one binder material, optionally at least one tackifier, optionally at least one plasticizer, and a solvent; c) casting the first anode layer slurry onto a substrate and drying the first anode layer slurry; and d) casting the second anode layer slurry onto the first anode layer slurry and drying the second anode layer slurry.

Further provided herein is an electrochemical cell comprising a bilayer anode of the present disclosure, a separator layer, and a cathode layer.

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 shows an electrochemical cell comprising a bilayer anode of the present disclosure. The cell was cycled at a stack pressure of about 300 psi at 29° C.

FIG. 2 shows an electrochemical cell comprising a bilayer anode of the present disclosure.

FIGS. 3A-3D show cycling data for electrochemical cells comprising a monolayer anode and electrochemical cells comprising a bilayer anode of the present disclosure. FIG. 3A shows the cell capacity retention over about 120 cycles. FIG. 3B shows the discharge capacity (mAh) over about 120 cycles. FIG. 3C shows the internal resistance (ohm) over about 120 cycles. FIG. 3D shows the efficiency over about 120 cycles.

FIGS. 4A-4C show cycling data for electrochemical cells comprising a monolayer anode shown as open circles (∘) and a bilayer anode of the present disclosure shown as solid circles (●). FIG. 4A shows the specific discharge capacity (mAh/g) over about 250 cycles. FIG. 4B shows the discharge capacity (mAh) over about 250 cycles. FIG. 4C shows the internal resistance (ohm) over about 250 cycles.

FIGS. 5A-5D show cycling data for electrochemical cells of the present disclosure comprising a tackifier and plasticizer shown as solid circles (●) as compared to a similar electrochemical cell without a plasticizer and a tackifer as open circles (∘). FIG. 5A shows the specific discharge capacity (mAh/g) over about 120 cycles. FIG. 5B shows the discharge capacity (mAh) over about 120 cycles. FIG. 5C shows the internal resistance (ohm) over about 120 cycles. FIG. 5D shows the efficiency over about 120 cycles.

FIGS. 6A-6D show cycling data for electrochemical cells of the present disclosure comprising a trilayer anode. FIG. 6A shows the specific discharge capacity (mAh/g) over about 40 cycles. FIG. 6B shows the discharge capacity (mAh) over about 40 cycles. FIG. 6C shows the internal resistance (ohm) over about 40 cycles. FIG. 6D shows the efficiency over about 40 cycles.

FIG. 7 shows the cell capacity retention for electrochemical cells of the present disclosure comprising a bilayer anode with no solid electrolyte material in the first anode layer, as well as cells having a monolayer anode.

### DETAILED DESCRIPTION

In the following description, specific details are provided to impart a thorough understanding of the various embodiments of the disclosure. Upon having read and understood the specification, claims, and drawings hereof, those skilled in the art will understand that some embodiments may be practiced without hewing to some of the specific details set forth herein. Moreover, to avoid obscuring the disclosure, some well-known methods, processes, devices, and systems utilized in the various embodiments described herein are not disclosed in detail.

Provided herein is an anode bilayer comprising a first anode layer in operable contact with a second anode layer. The first anode layer and the second anode layer each independently comprise an anode active material, a binder, a conductive additive, and optionally a solid electrolyte material. The amount of the anode active material, binder, conductive additive, and/or the solid electrolyte material in the first anode layer is different from the amount of the anode active material, binder, conductive additive, and/or the solid electrolyte material in the second anode layer.

Also provided herein are compositions comprising an anode bilayer comprising a first layer and a second layer. The first layer includes a first anode active material, a first binder, a first conductive additive, and optionally a first solid electrolyte material. The first anode active material is present in the first layer in an amount of greater than or equal to about 50% by weight of the first layer. The second layer includes a second anode active material, a second binder, a second conductive additive, and a second solid electrolyte material. The second anode active material is present in the second layer in an amount of greater than or equal to about 50% by weight of the second layer. The first anode active material and the second anode active material may be the same anode active material, or they may be different. The first binder and the second binder may be the same binder, or they may be different. The first conductive additive and the second conductive additive may be the same conductive additive, or they may be different. The first solid electrolyte material and the second electrolyte material may be the same solid electrolyte material, or they may be different.

It should be understood that within the meaning of this disclosure, the phrase “first anode active material” may refer to a single anode active material or to more than one anode active materials. That is, the label “first” or “second” should not be construed to limit the referenced anode active material to a single species. Moreover, phrases such as “the anode active material” or “an anode active material” should be construed to also refer to the first anode active material and/or the second anode active material. Similarly, references to “the anode layer” should be construed to include references to the first anode layer and/or to the second anode layer.

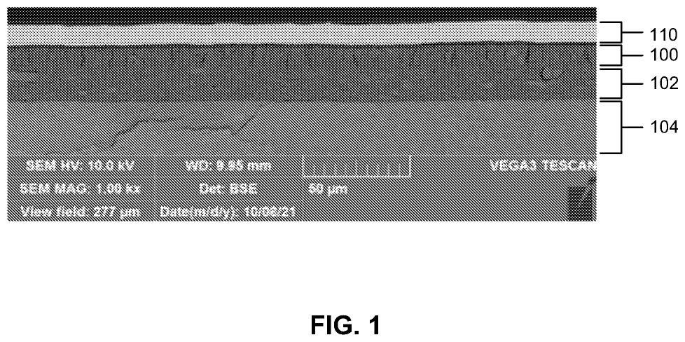

FIG. 1 shows an electrochemical cell comprising an anode bilayer of the present disclosure. The first anode layer 100 may contact an anode current collector 110. The second anode layer 102 may contact a separator layer 104 (also referred to as an electrolyte layer). The first anode layer 100 and the second anode layer 102 may be in direct contact with each other. The separator layer 104 may contact a cathode layer 106. The cathode layer 106 may contact a cathode current collector 108.

Each anode layer comprises an anode active material. The anode active material preferably is an inorganic material. The anode active material may comprise one or more inorganic materials such as silicon (Si), silicon alloys (e.g., LiₓSi), tin (Sn), tin alloys, germanium (Ge), germanium alloys, graphite, Li₄Ti₅O₁₂ (LTO) or other known anode active materials and combinations thereof. In preferred embodiments, the anode active material comprises silicon.

The silicon or silicon alloy in the first anode layer may have an average particle size of less than about 1 micron. As used herein, “silicon” refers to silicon metal or an alloy thereof unless otherwise stated. The average particle size (i.e., Do) of the silicon may be described using methods well-known in the art. In some aspects, the silicon may have an average particle size of less than 500 nm, less than 450 nm, less than 400 nm, less than 350 nm, less than 300 nm, less than 250 nm, less than 200 nm, less than 150 nm, or less than 100 nm. In some examples, the silicon has an average particle size of about 100 nm. In an exemplary embodiment, the silicon has an average particle size of about 50 nm to about 150 nm. In some additional aspects, the silicon or silicon alloy may have an average particle size of about 50 nm to about 100 nm, about 100 nm to about 150 nm, about 150 nm to about 200 nm, about 200 nm to about 300 nm, about 300 nm to about 400 nm, about 400 nm to about 500 nm, about 500 nm to about 600 nm, about 600 nm to about 700 nm, about 700 nm to about 800 nm, about 800 nm to about 900 nm, or about 900 nm to about 1000 nm. In still further aspects, the silicon or silicon alloy may have an average particle size of about 50 nm to about 150 nm, about 50 nm to about 200 nm, about 50 nm to about 300 nm, about 50 nm to about 400 nm, about 50 nm to about 500 nm, about 50 nm to about 600 nm, about 50 nm to about 700 nm, about 50 nm to about 800 nm, about 50 nm to about 900 nm, or about 50 nm to about 1000 nm.

The silicon or silicon alloy in the first anode layer may have an average particle size about 1 micron. In some aspects, the silicon or silicon alloy may have an average particle size of about 50 nm to about 100 nm, about 100 nm to about 150 nm, about 150 nm to about 200 nm, about 200 nm to about 300 nm, about 300 nm to about 400 nm, about 400 nm to about 500 nm, about 500 nm to about 600 nm, about 600 nm to about 700 nm, about 700 nm to about 800 nm, about 800 nm to about 900 nm, about 900 nm to about 1 micron, about 1 micron to about 2 microns, about 2 microns to about 3 microns, about 3 microns to about 4 microns, or about 4 microns to about 5 microns. In still further aspects, the silicon or silicon alloy may have an average particle size of about 50 nm to about 150 nm, about 50 nm to about 200 nm, about 50 nm to about 300 nm, about 50 nm to about 400 nm, about 50 nm to about 500 nm, about 50 nm to about 600 nm, about 50 nm to about 700 nm, about 50 nm to about 800 nm, about 50 nm to about 900 nm, about 50 nm to about 1 micron, about 50 nm to about 2 microns, about 50 nm to about 3 microns, about 50 nm to about 4 microns, about 50 nm to about 5 microns, about 100 nm to about 5 microns, about 150 nm to about 5 microns, about 200 nm to about 5 microns, about 300 nm to about 5 microns, about 400 nm to about 5 microns, about 500 nm to about 5 microns, about 600 nm to about 5 microns, about 700 nm to about 5 microns, about 800 nm to about 5 microns, about 900 nm to about 5 microns, about 1 micron to about 5 microns, about 2 microns to about 5 microns, or about 3 microns to about 5 microns.

The silicon or silicon alloy in the second anode layer may have an average particle size of less than about 1 micron. The average particle size (i.e., Do) of the silicon may be described using methods well-known in the art. In some aspects, the silicon may have an average particle size of less than 500 nm, less than 450 nm, less than 400 nm, less than 350 nm, less than 300 nm, less than 250 nm, less than 200 nm, less than 150 nm, or less than 100 nm. In some examples, the silicon has an average particle size of about 100 nm. In an exemplary embodiment, the silicon has an average particle size of about 50 nm to about 150 nm. In some additional aspects, the silicon or silicon alloy may have an average particle size of about 50 nm to about 100 nm, about 100 nm to about 150 nm, about 150 nm to about 200 nm, about 200 nm to about 300 nm, about 300 nm to about 400 nm, about 400 nm to about 500 nm, about 500 nm to about 600 nm, about 600 nm to about 700 nm, about 700 nm to about 800 nm, about 800 nm to about 900 nm, or about 900 nm to about 1000 nm. In still further aspects, the silicon or silicon alloy may have an average particle size of about 50 nm to about 150 nm, about 50 nm to about 200 nm, about 50 nm to about 300 nm, about 50 nm to about 400 nm, about 50 nm to about 500 nm, about 50 nm to about 600 nm, about 50 nm to about 700 nm, about 50 nm to about 800 nm, about 50 nm to about 900 nm, or about 50 nm to about 1000 nm.

The silicon or silicon alloy in the second anode layer may have an average particle size about 1 micron. In some aspects, the silicon or silicon alloy may have an average particle size of about 50 nm to about 100 nm, about 100 nm to about 150 nm, about 150 nm to about 200 nm, about 200 nm to about 300 nm, about 300 nm to about 400 nm, about 400 nm to about 500 nm, about 500 nm to about 600 nm, about 600 nm to about 700 nm, about 700 nm to about 800 nm, about 800 nm to about 900 nm, about 900 nm to about 1 micron, about 1 micron to about 2 microns, about 2 microns to about 3 microns, about 3 microns to about 4 microns, or about 4 microns to about 5 microns. In still further aspects, the silicon or silicon alloy may have an average particle size of about 50 nm to about 150 nm, about 50 nm to about 200 nm, about 50 nm to about 300 nm, about 50 nm to about 400 nm, about 50 nm to about 500 nm, about 50 nm to about 600 nm, about 50 nm to about 700 nm, about 50 nm to about 800 nm, about 50 nm to about 900 nm, about 50 nm to about 1 micron, about 50 nm to about 2 microns, about 50 nm to about 3 microns, about 50 nm to about 4 microns, about 50 nm to about 5 microns, about 100 nm to about 5 microns, about 150 nm to about 5 microns, about 200 nm to about 5 microns, about 300 nm to about 5 microns, about 400 nm to about 5 microns, about 500 nm to about 5 microns, about 600 nm to about 5 microns, about 700 nm to about 5 microns, about 800 nm to about 5 microns, about 900 nm to about 5 microns, about 1 micron to about 5 microns, about 2 microns to about 5 microns, or about 3 microns to about 5 microns.

The anode active material may be present in the first anode layer in an amount greater than or equal to about 40% by weight. In some aspects, the anode active material may be present in the first anode layer in an amount of about 35% to about 85% by weight, about 40% to about 85% by weight, about 40% to about 80% by weight, about 40% to about 75% by weight, about 40% to about 70% by weight, about 40% to about 65% by weight, about 40% to about 60% by weight, about 40% to about 55% by weight, or about 40% to about 50% by weight. In some additional aspects, the anode active material may be present in the first anode layer in an amount greater than or equal to about 50% by weight. In some examples, the anode active material is present in the first anode layer in an amount of about 50% to about 60% by weight. In some additional aspects the anode active material may be present in the first anode layer in an amount of about 40% to about 50% by weight, about 50% to about 60% by weight, about 60% to about 70% by weight, about 70% to about 80% by weight, or about 80% to about 85% by weight.

The anode active material may be present in the second anode layer in an amount of about 20% to about 70% by weight of the second anode layer. In some aspects, the anode active material may be present in the second anode layer in an amount of about 20% by weight to about 70% by weight, about 20% by weight to about 65% by weight, about 20% by weight to about 60% by weight, about 20% by weight to about 55% by weight, about 20% by weight to about 50% by weight, about 20% to about 45% by weight, about 20% to about 40% by weight, about 20% to about 35% by weight, about 20% to about 30% by weight, about 25% to about 50% by weight, about 25% to about 45% by weight, about 25% to about 40% by weight, about 25% to about 35% by weight, about 30% to about 50% by weight, about 30% to about 45% by weight, about 30% to about 40% by weight, about 35% to about 50% by weight, about 35% to about 45% by weight, or about 40% to about 50% by weight. In some additional aspects, the anode active material may be present in the second anode layer in an amount of about 20% to about 25% by weight, about 25% to about 30% by weight, about 30% to about 35% by weight, about 35% to about 40% by weight, about 40% to about 45% by weight, or about 45% to about 50% by weight.

In some embodiments, the composition comprises a third anode layer. The third anode layer may be disposed adjacent to the second anode layer and, if present, adjacent to a separator layer.

The anode active material may be present in the third anode layer in an amount of about 10% to about 90% by weight of the third layer. The third anode layer may be disposed adjacent to the second anode layer and, when present, a separator layer. In some aspects, the anode active material may be present in the third anode layer in an amount of about 10% to about 20% by weight, about 10% to about 30% by weight, about 10% to about 40% by weight, about 10% to about 50% by weight, about 10% to about 60% by weight, about 10% to about 70% by weight, about 10% to about 80% by weight, about 20% to about 90% by weight, about 30% to about 90% by weight, about 40% to about 90% by weight, about 50% to about 90% by weight, about 60% to about 90% by weight, about 70% to about 90% by weight, or about 80% to about 90% by weight.

In some embodiments, the composition may further comprise a fourth anode layer, a fifth anode layer, a sixth anode layer, . . . or an n^{th} layer.

In another embodiment, the anode active material in any anode layer, including the first anode layer, the second anode layer, the third anode layer . . . and the n^{th} anode layer, may be present in an amount of about 5% to about 99% by weight of the anode layer. For example, the anode active material may be present in any anode layer in an amount of about 5% to about 10%, about 5% to about 20%, about 5% to about 30%, about 5% to about 40%, about 5% to about 50%, about 5% to about 60%, about 5% to about 70%, about 5% to about 80%, about 5% to about 90%, about 5% to about 95%, about 10% to about 99%, about 20% to about 99%, about 30% to about 99%, about 40% to about 99%, about 50% to about 99%, about 60% to about 99%, about 70% to about 99%, about 80% to about 99%, about 90% to about 99%, or about 95% to about 99% by weight of the anode layer. In other examples, the anode active material may be present in any anode layer in an amount of about 5% to about 10%, about 10% to about 20%, about 20% to about 30%, about 30% to about 40%, about 40% to about 50%, about 50% to about 60%, about 60% to about 70%, about 70% to about 80%, about 80% to about 90%, about 90% to about 95%, or about 95% to about 99% by weight of the anode layer.

Generally, each anode layer comprises a conductive additive. The conductive additive helps to evenly distribute the charge density throughout the anode. The conductive additives may include metal powders, fibers, filaments, or any other material known to conduct electrons. The conductive additive may comprise a carbon-based conductive additive, such as carbon fiber, graphite, graphene, carbon black, conductive carbon, amorphous carbon, vapor grown carbon fiber (VGCF), carbon nanotubes, carbon nanowires, activated carbon, and combinations thereof.

In some embodiments, the conductive additive may be present in the anode layer in an amount of about 0% to about 15% by weight of the anode layer. In some aspects, the conductive additive may be present in the anode layer in an amount of about 0% to about 10%, or about 0% to about 5% by weight of the anode layer. In some additional aspects, the conductive additive may be present in the anode layer in an amount of about 0%, 1%, 2%, 3%, 4%, 5%, 6%, 7%, 8%, 9%, 10%, 11%, 12%, 13%, 14%, or about 15% by weight of the anode layer. In an exemplary embodiment, the conductive additive is present in the anode layer in an amount of about 0% to about 5% by weight of the anode layer.

In some embodiments, the average particle size of the conductive additive may be about 5 nm to about 100 nm. In some aspects, the average particle size of the conductive additive may be about 5 nm to about 10 nm, about 5 nm to about 20 nm, about 5 nm to about 30 nm, about 5 nm to about 40 nm, about 5 nm to about 50 nm, about 5 nm to about 60 nm, about 5 nm to about 70 nm, about 5 nm to about 80 nm, about 5 nm to about 90 nm, about 10 nm to about 100 nm, about 20 nm to about 100 nm, about 30 nm to about 100 nm, about 40 nm to about 100 nm, about 50 nm to about 100 nm, about 60 nm to about 100 nm, about 70 nm to about 100 nm, about 80 nm to about 100 nm, about 90 nm to about 100 nm, about 10 nm to about 50 nm, or about 20 nm to about 40 nm. In some examples, the conductive additive may have a particle size of about 30 nm.

In some additional embodiments, the average particle size of the conductive additive may be up to about 7 microns; including about 0.1 microns, about 0.5 microns, about 1 micron, about 1.5 microns, about 2 microns, about 2.5 microns, about 3 microns, about 3.5 microns, about 4 microns, about 4.5 microns, about 5 microns, about 5.5 microns, about 6 microns, about 6.5 microns, or about 7 microns. In a particular example, the conductive additive is graphite having an average particle size of about 6 microns.

One or both anode layer may comprise a solid electrolyte material. The solid electrolyte material, along with the conductive additive, helps to evenly distribute the charge density throughout the anode. The one or more solid electrolyte material may comprise an oxide, oxysulfide, sulfide, halide, nitride, or any other solid electrolyte known in the art. In some preferred embodiments, the one or more solid electrolyte materials may comprise a sulfide solid electrolyte material, i.e., a solid electrolyte having at least one sulfur component. In some embodiments, the one or more solid electrolytes may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(β-Ω)}, where: 0≤β≤1; 0≤Ω≤6; α=6−[(β*4)+(1−β)*3]; X and Y are a halogen such as F, Cl, Br, I; M is an element with an oxidation state of 4+ such as Ti, Zr, Hf, and Rf; and N is an element an oxidation state of 3+ such as Ga, In, and Tl, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In some embodiments, the first anode layer may comprise substantially no solid electrolyte material. Without wishing to be bound by theory, it is believed that reducing the amount of solid electrolyte material in the first anode layer reduces corrosion in the current collector, particularly when the current collector comprises copper. As used herein “substantially no solid electrolyte” refers to the presence of the solid electrolyte in the first anode layer in an amount of about 5% by weight or less of the first anode layer. For example, a first anode layer comprising substantially no solid electrolyte material may comprise 5% or less, 4% or less, 3% or less, 2% or less, 1% or less, 0.5% or less, 0.1% or less, 0.05% or less, or 0.01% or less of a solid electrolyte material by weight of the first anode layer. In some additional embodiments, the first anode layer may be devoid of a solid electrolyte material.

In other embodiments, the anode layer may include a semi-solid, or a liquid electrolyte.

In another embodiment, the solid electrolyte material may be one or more of a Li₃PS₄, Li₄P₂S₆, Li₇P₃S₁₁, Li₁₀GeP₂S₁₂, Li₁₀SnP₂S₁₂. In a further embodiment, the solid electrolyte may be one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y≤2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the solid electrolyte material be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

In some aspects, the solid electrolyte material may be present in the anode layer in an amount of about 0% to about 70% by weight of the anode layer; for example, the solid electrolyte may be present in the anode layer in an amount of about 0% to about 10% by weight, about 0% to about 20% by weight, about 0% to about 30% by weight, about 0% to about 40% by weight, about 0% to about 50% by weight, about 0% to about 60% by weight, about 10% to about 70% by weight, about 20% to about 70% by weight, about 30% to about 70% by weight, about 40% to about 70% by weight, about 50% to about 70% by weight, or about 60% to about 70% by weight. In some aspects, the solid electrolyte material may be present in the anode layer in an amount of about 5%, 10%, 15%, 20%, 25%, 30%, 35%, 40%, 45%, 50%, 55%, 60%, 65%, or about 70% by weight of the anode layer. In preferred embodiments, the solid electrolyte material is present in an amount of about 20% to about 30% by weight of the anode layer.

In some additional aspects, the solid electrolyte material may be present in the anode layer in an amount of less than about 60% by weight of the anode layer; for example, the solid electrolyte may be present in the anode layer in an amount of less than about 55% by weight of the anode layer, less than about 50% by weight of the anode layer, less than about 45% by weight of the anode layer, less than about 40% by weight of the anode layer, less than about 35% by weight of the anode layer, less than about 30% by weight of the anode layer, less than about 25% by weight of the anode layer, less than about 20% by weight of the anode layer, less than about 15% by weight of the anode layer, less than about 10% by weight of the anode layer, or less than about 5% by weight of the anode layer. In preferred embodiments, the solid electrolyte material is present in an amount of less than about 25% by weight of the anode layer.

The solid electrolyte material may have an average particle size of about 0.5 to about 2 microns. In some embodiments, the solid electrolyte material may have a particle size of about 0.5 microns to about 0.75 microns, about 0.75 microns to about 1 micron, about 1 micron to about 1.25 microns, about 1.25 microns to about 1.5 microns, about 1.5 microns to about 1.75 microns, or about 1.75 microns to a bout 2 microns. In preferred embodiments, the solid electrolyte material has a particle size of about 1 micron.

Generally, the anode layer comprises a binder. The binder aids in adhesion of the first anode layer to the current collector and the adhesion of the second anode layer to the first anode layer and the separator layer. The binder also forms a flexible matrix when mixed with the solid electrolyte material. The binder further allows the anode active material and the conductive additive to be suspended in the electrolyte matrix, allowing the electrode layer to maintain particle-to-particle contact while the anode active material expands and contracts.

In some embodiments, the binder may comprise fluororesin containing vinylidene fluoride (VdF), hexafluoropropylene (HFP), tetrafluoroethylene (TFE), and derivatives thereof as structural units. In some additional embodiments, the binder may comprise homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR) and the like. In other embodiments, the binder may include cellulosic binders such as carboxymethylcellulose (CMC). In further embodiments, the binder may be one or more of a styrene-based thermoplastic, such as but not limited to styrene-butadiene rubber (SBR), styrene-butadiene-styrene block copolymer (SBS), styrene-isoprene block copolymer (SIS), polystyrene (PS), or styrene-ethylene-butylene-styrene block copolymer (SEBS). In other embodiments, the binder may comprise one or more of styrene-butadiene rubber (SBR), polyvinylidene fluoride (PVdF), carboxymethylcellulose (CMC), or combinations thereof or derivatives thereof.

In a further embodiment, the binder may be one or more of an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof.

In preferred embodiments, the binder may comprise a styrenic block copolymer or a styrene-based thermoplastic. In some aspects, the binder may be present in the anode layer in an amount of about 0% to about 20% by weight of the anode layer; for example, the binder may be present in the anode layer in an amount of about 0% to about 5%, about 0% to about 10%, about 0% to about 15%, about 5% to about 20%, about 10% to about 20%, or about 15% to about 20%. In an exemplary embodiment, the binder is present in the anode layer in an amount of about 4% to about 5% by weight.

The anode layer may comprise a tackifier. The tackifier increases tack of the anode layer, i.e., how quickly an adhesive bond is formed. Generally, the tackifier may include a hydrocarbon resin, such as a hydrogenated aromatic resin, an aromatic resin, a terpene resin, a modified terpene resin, an aliphatic resin, a cycloaliphatic resin, a hydrogenated hydrocarbon resin, and combinations thereof. Such resins and methods of procuring and making the same are generally known in the art. Preferably, the tackifier and the binder are miscible; i.e., have similar solubility parameters. Without wishing to be bound by theory, when the tackifier and the binder are miscible, then the mixture will have a lower modulus and a higher glass transition temperature as compared to a binder and a tackifier that are not miscible. In preferred embodiments, the tackifier is a hydrogenated aromatic resin. In preferred embodiments, only the second anode layer comprises a tackifier; i.e., there is no tackifier in the first anode layer.

The tackifier may have a softening point from about 20° C. to about 150° C. The tackifier may have a molecular weight from about 300 g/mol to about 10,000 g/mol. The tackifier may have a density of about 0.75 kg/L to about 1.25 kg/L. The tackifier may have a glass transition temperature from about −30° C. to about 150° C.

The tackifier may be present in an amount of about 0% to about 15% by weight of the anode layer. In some aspects, the tackifier may be present in an amount of about 0% to about 5% by weight of the anode layer, about 0% to about 10% by weight of the anode layer, about 5% to about 10% by weight of the anode layer, or about 10% to about 15% by weight of the anode layer. In an exemplary embodiment, the tackifier is present in an amount of about 10% by weight of the anode layer.

The anode layer may comprise a plasticizer. The plasticizer increases the flexibility of the anode layer, thus making it less susceptible to damage and cracking during volume expansion and contraction. Plasticizers may include phthalates, sebecates, adipates, and other esters. Phthalates may include dimethyl phthalate, diethyl phthalate, dipropyl phthalate, dibutyl phthalate, dipentyl phthalate, dihexyl phthalate, diheptyl phthalate, dioctyl phthalate, dinonyl phthalate, didecyl phthalate, diundecyl phthalate, didodecyl phthalate, and other phthalates and isomers or derivatives thereof. Sebacates may include dimethyl sebacate, diethyl sebacate, dipropyl sebacate, dibutyl sebacate, dipentyl sebacate, dihexyl sebacate, diheptyl sebacate, dioctyl sebacate, dinonyl sebacate, didecyl sebacate, diundecyl sebacate, didodecyl sebacate, and other sebacates and isomers or derivatives thereof. Adipates may include dimethyl adipate, diethyl adipate, dipropyl adipate, dibutyl adipate, dipentyl adipate, dihexyl adipate, diheptyl adipate, dioctyl adipate, dinonyl adipate, didecyl adipate, diundecyl adipate, didodecyl adipate, and other adipates and isomers or derivatives thereof. In particular embodiments, the plasticizer may include dioctyl phthalate, dibutyl sebecate, mineral oil, or other plasticizers known in the art or combinations thereof. In preferred embodiments, only the second anode layer comprises a plasticizer; i.e., there is no plasticizer in the first anode layer.

The plasticizer may be present in the anode layer in an amount of about 0% to about 8% by weight of the anode layer. In some aspects, the plasticizer may be present in the anode layer in an amount of about 0% to about 2% by weight of the anode layer, about 0% to about 4% by weight of the anode layer, about 0% to about 6% by weight of the anode layer, about 2% to about 4% by weight of the anode layer, about 2% to about 6% by weight of the anode layer, about 2% to about 8% by weight of the anode layer, about 4% to about 6% by weight of the anode layer, about 4% to about 8% by weight of the anode layer, or about 6% to about 8% by weight of the anode layer. In an exemplary embodiment, the plasticizer is present in the anode layer in an amount of about 4% by weight of the anode layer.

The anode layer composition may be densified using densification methods known by those having ordinary skill in the art, including calendering, linear pressing, etc.

Prior to densification and before drying (i.e., removal of any solvent), the first anode layer may have a thickness of about 50 microns to about 100 microns. In some aspects, the first anode layer may have a thickness of about 50 microns to about 60 microns, about 50 microns to about 70 microns, about 50 microns to about 80 microns, about 50 microns to about 90 microns, about 60 microns to about 70 microns, about 60 microns to about 80 microns, about 60 microns to about 90 microns, about 60 microns to about 100 microns, about 70 microns to about 80 microns, about 70 microns to about 90 microns, about 70 microns to about 100 microns, about 80 microns to about 90 microns, about 80 microns to about 100 microns, or about 90 microns to about 100 microns prior to densification and before drying. In preferred embodiments, the composition may have a thickness of about 70 microns prior to densification and before drying.

Prior to densification and after drying, the first anode layer may have a thickness of about 15 microns to about 50 microns. In some aspects, the first anode layer may have a thickness of about 15 microns to about 20 microns, about 20 microns to about 30 microns, about 30 microns to about 40 microns, about 40 microns to about 50 microns, about 15 microns to about 30 microns, about 15 microns to about 40 microns, about 20 microns to about 50 microns, about 30 microns to about 50 microns, or about 40 microns to about 50 microns prior to densification and after drying.

Prior to densification and before drying, the second anode layer may have a thickness of about 20 microns to about 70 microns. In some embodiments, the second anode layer may have a thickness of about 20 microns to about 30 microns, about 20 microns to about 40 microns, about 20 microns to about 50 microns, about 20 microns to about 60 microns, about 30 microns to about 40 microns, about 30 microns to about 50 microns, about 30 microns to about 60 microns, about 30 microns to about 70 microns, about 40 microns to about 50 microns, about 40 microns to about 60 microns, about 40 microns to about 70 microns, about 50 microns to about 60 microns, about 50 microns to about 70 microns, or about 60 microns to about 70 microns prior to densification and before drying. In preferred embodiments, the second anode layer may have a thickness of about 50 microns prior to densification and before drying.

Prior to densification and after drying, the first anode layer may have a thickness of about 15 microns to about 50 microns. In some aspects, the first anode layer may have a thickness of about 15 microns to about 20 microns, about 20 microns to about 30 microns, about 30 microns to about 40 microns, about 40 microns to about 50 microns, about 15 microns to about 30 microns, about 15 microns to about 40 microns, about 20 microns to about 50 microns, about 30 microns to about 50 microns, or about 40 microns to about 50 microns prior to densification and after drying.

Generally, the thickness of the first anode layer may be greater than the thickness of the second anode layer. In some embodiments, the thickness of the first anode layer may be about 10% greater than the thickness of the second anode layer, about 20% greater than the thickness of the second anode layer, about 30% greater than the thickness of the second anode layer, about 40% greater than the thickness of the second anode layer, about 50% greater than the thickness of the second anode layer, about 60% greater than the thickness of the second anode layer, or about 70% greater than the thickness of the second anode layer. In an exemplary embodiment, the thickness of the first anode layer is about 40% greater than the thickness of the second anode layer.

A stack pressure of about 3000 psi or less may be applied to the composition. In some embodiments, the stack pressure may be about 3000 psi or less, about 2500 psi or less, about 2000 psi or less, about 1500 psi or less, about 1000 psi or less, about 750 psi or less, about 500 psi or less, or about 250 psi or less. In an exemplary embodiment, a stack pressure of about 1500 psi or less is applied to the composition. In some additional embodiments, the stack pressure applied to the composition may be from about 100 psi to about 250 psi, about 100 psi to about 500 psi, about 100 psi to about 750 psi, about 100 psi to about 1000 psi, about 100 psi to about 1500 psi, about 100 psi to about 2000 psi, about 100 psi to about 2500 psi, about 100 psi to about 3000 psi about 250 psi to about 3000 psi, about 500 psi to about 3000 psi, about 750 psi to about 3000 psi, about 1000 psi to about 3000 psi, about 1500 psi to about 3000 psi, about 2000 psi to about 3000 psi, about 2500 psi to about 3000 psi, about 250 psi to about 2500 psi, about 750 psi to about 2000 psi, or about 1000 psi to about 2000 psi.

After a first cell cycle or a series of conditioning cycles, the composition may form vertical cracks. As used herein “vertical” cracks refer to cracks that are substantially perpendicular in relation to a boundary—plane—between the anode and an adjacent anode current collector and that have few or no branches in the cracks. In some embodiments, the cracks may be oriented at a 90° angle±about 25° relative to the anode current collector; for example, the cracks may be oriented at an angle of about 65° to about 115°, about 70° to about 110°, about 80° to about 100°, about 85° to about 95°, about 80° to about 90°, about 85° to about 90°, about 90° to about 100°, or about 90° to about 95°. In some additional examples, the cracks may be oriented at an angle of about 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89°, 90°, 91°, 92°, 93°, 94°, 95°, 96°, 97°, 98°, 99°, 100°, 101°, 102°, 103°, 104°, 1050, 106°, 107°, 108°, 109°, 110°, 111°, 112°, 113°, 114°, or about 115° relative to the anode current collector. In some additional embodiments, the cracks may be orthogonal to the anode current collector.

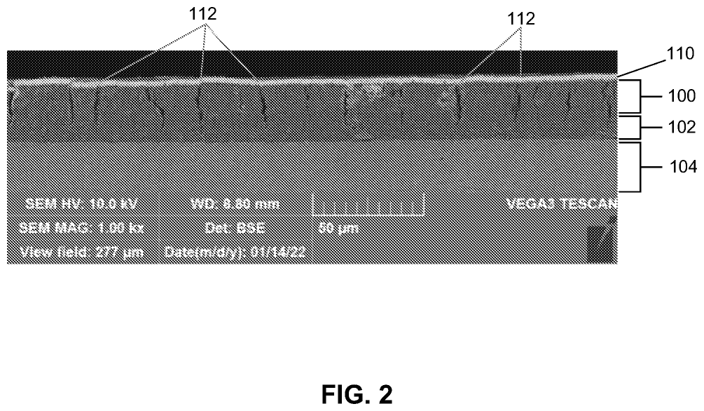

FIG. 2 shows an electrochemical cell comprising an anode bilayer of the present disclosure. The first anode layer 100 comprises a plurality of vertical cracks 112. The cracks may form during the first cell cycle of the electrochemical cell or during a series of conditioning cycles.

The first anode layer may comprise vertical cracks. In an exemplary embodiment, the first anode layer may have cracks as shown in FIG. 2. The second anode layer may comprise vertical cracks.

In some examples, the second anode layer may have smaller and/or less pronounced cracks as compared to the first anode layer. In some examples, the second anode layer may have no cracks.

The first anode layer may have a density from about 1.0 g/cm³ to about 2.0 g/cm³. In some embodiments, the first anode layer may have a density from about 1.0 g/cm³ to about 1.1 g/cm³, about 1.1 g/cm³ to about 1.2 g/cm³, about 1.2 g/cm³ to about 1.3 g/cm³, about 1.3 g/cm³ to about 1.4 g/cm³, about 1.4 g/cm³ to about 1.5 g/cm³, about 1.5 g/cm³ to about 1.6 g/cm³, about 1.6 g/cm³ to about 1.7 g/cm³, about 1.7 g/cm³ to about 1.8 g/cm³, about 1.8 g/cm³ to about 1.9 g/cm³, about 1.9 g/cm³ to about 2.0 g/cm³, about 1.0 g/cm³ to about 1.2 g/cm³, about 1.0 g/cm³ to about 1.3 g/cm³, about 1.0 g/cm³ to about 1.4 g/cm³, about 1.0 g/cm³ to about 1.5 g/cm³, about 1.0 g/cm³ to about 1.6 g/cm³, about 1.0 g/cm³ to about 1.7 g/cm³, about 1.0 g/cm³ to about 1.8 g/cm³, about 1.0 g/cm³ to about 1.9 g/cm³, about 1.1 g/cm³ to about 2.0 g/cm³, about 1.2 g/cm³ to about 2.0 g/cm³, about 1.3 g/cm³ to about 2.0 g/cm³, about 1.4 g/cm³ to about 2.0 g/cm³, about 1.5 g/cm³ to about 2.0 g/cm³, about 1.6 g/cm³ to about 2.0 g/cm³, about 1.7 g/cm³ to about 2.0 g/cm³, about 1.8 g/cm³ to about 2.0 g/cm³, or about 1.9 g/cm³ to about 2.0 g/cm³.

The density of the second anode layer may be the same as or higher than the density of the first anode layer. The second anode layer may have a density from about 1.0 g/cm³ to about 2.0 g/cm³. In some embodiments, the second anode layer may have a density from about 1.0 g/cm³ to about 1.1 g/cm³, about 1.1 g/cm³ to about 1.2 g/cm³, about 1.2 g/cm³ to about 1.3 g/cm³, about 1.3 g/cm³ to about 1.4 g/cm³, about 1.4 g/cm³ to about 1.5 g/cm³, about 1.5 g/cm³ to about 1.6 g/cm³, about 1.6 g/cm³ to about 1.7 g/cm³, about 1.7 g/cm³ to about 1.8 g/cm³, about 1.8 g/cm³ to about 1.9 g/cm³, about 1.9 g/cm³ to about 2.0 g/cm³, about 1.0 g/cm³ to about 1.2 g/cm³, about 1.0 g/cm³ to about 1.3 g/cm³, about 1.0 g/cm³ to about 1.4 g/cm³, about 1.0 g/cm³ to about 1.5 g/cm³, about 1.0 g/cm³ to about 1.6 g/cm³, about 1.0 g/cm³ to about 1.7 g/cm³, about 1.0 g/cm³ to about 1.8 g/cm³, about 1.0 g/cm³ to about 1.9 g/cm³, about 1.1 g/cm³ to about 2.0 g/cm³, about 1.2 g/cm³ to about 2.0 g/cm³, about 1.3 g/cm³ to about 2.0 g/cm³, about 1.4 g/cm³ to about 2.0 g/cm³, about 1.5 g/cm³ to about 2.0 g/cm³, about 1.6 g/cm³ to about 2.0 g/cm³, about 1.7 g/cm³ to about 2.0 g/cm³, about 1.8 g/cm³ to about 2.0 g/cm³, or about 1.9 g/cm³ to about 2.0 g/cm³.

Any remaining anode layers (e.g., the third anode layer, the fourth anode layer, etc.) may have a density from about 1.0 g/cm³ to about 2.0 g/cm³. In some embodiments, the anode layer may have a density from about 1.0 g/cm³ to about 1.1 g/cm³, about 1.1 g/cm³ to about 1.2 g/cm³, about 1.2 g/cm³ to about 1.3 g/cm³, about 1.3 g/cm³ to about 1.4 g/cm³, about 1.4 g/cm³ to about 1.5 g/cm³, about 1.5 g/cm³ to about 1.6 g/cm³, about 1.6 g/cm³ to about 1.7 g/cm³, about 1.7 g/cm³ to about 1.8 g/cm³, about 1.8 g/cm³ to about 1.9 g/cm³, about 1.9 g/cm³ to about 2.0 g/cm³, about 1.0 g/cm³ to about 1.2 g/cm³, about 1.0 g/cm³ to about 1.3 g/cm³, about 1.0 g/cm³ to about 1.4 g/cm³, about 1.0 g/cm³ to about 1.5 g/cm³, about 1.0 g/cm³ to about 1.6 g/cm³, about 1.0 g/cm³ to about 1.7 g/cm³, about 1.0 g/cm³ to about 1.8 g/cm³, about 1.0 g/cm³ to about 1.9 g/cm³, about 1.1 g/cm³ to about 2.0 g/cm³, about 1.2 g/cm³ to about 2.0 g/cm³, about 1.3 g/cm³ to about 2.0 g/cm³, about 1.4 g/cm³ to about 2.0 g/cm³, about 1.5 g/cm³ to about 2.0 g/cm³, about 1.6 g/cm³ to about 2.0 g/cm³, about 1.7 g/cm³ to about 2.0 g/cm³, about 1.8 g/cm³ to about 2.0 g/cm³, or about 1.9 g/cm³ to about 2.0 g/cm³.

The first anode layer may have a porosity from about 25% to about 50%. Methods of measuring porosity are generally known in the art. In some embodiments, the first anode layer may have a porosity of about 25% to about 30%, about 25% to about 35%, about 25% to about 40%, about 25% to about 45%, about 30% to about 35%, about 30% to about 40%, about 30% to about 45%, about 30% to about 50%, about 35% to about 40%, about 35% to about 45%, about 35% to about 50%, about 40% to about 45%, about 40% to about 50%, or about 45% to about 50%. In an exemplary embodiment, the first anode layer has a porosity of about 40%.

The second anode layer may have a porosity of about 10% to about 50%. Generally, the second anode layer has a lower porosity than the first anode layer because there is less expansion and contraction in the second anode layer. In some embodiments, the second anode layer may have a porosity of about 10% to about 15%, about 10% to about 20%, about 10% to about 25%, about 10% to about 30%, about 10% to about 35%, about 10% to about 40%, about 10% to about 45%, about 15% to about 20%, about 15% to about 25%, about 15% to about 30%, about 15% to about 35%, about 15% to about 40%, about 15% to about 45%, about 15% to about 50%, about 20% to about 25%, about 20% to about 30%, about 20% to about 35%, about 20% to about 40%, about 20% to about 45%, about 20% to about 50%, about 25% to about 30%, about 25% to about 35%, about 25% to about 40%, about 25% to about 45%, about 30% to about 35%, about 30% to about 40%, about 30% to about 45%, about 30% to about 50%, about 35% to about 40%, about 35% to about 45%, about 35% to about 50%, about 40% to about 45%, about 40% to about 50%, or about 45% to about 50%.

The anode layer may be a solid-state anode layer.

In the exemplary electrochemical cell shown in FIG. 1, the first anode layer 100 comprises silicon in an amount of about 60% by weight, styrene-based thermoplastic in an amount of about 7% by weight, a carbon-based conductive additive in an amount of about 5% by weight, and a sulfide solid electrolyte in an amount of about 28% by weight. The second anode layer 102 comprises silicon in an amount of about 30% by weight, a carbon-based conductive additive in an amount of about 5% by weight, styrene-based thermoplastic in an amount of about 7% by weight, and a sulfide solid electrolyte in an amount of about 58% by weight.

In the exemplary electrochemical cell shown in FIG. 2, the first anode layer 100 comprises silicon in an amount of about 60% by weight, styrene-based thermoplastic in an amount of about 7% by weight, and a solid electrolyte in an amount of about 33% by weight. The second anode layer 102 comprises silicon in an amount of about 30% by weight, a carbon-based conductive additive in an amount of about 5% by weight, a sulfide solid state electrolyte material in an amount of about 45% by weight, and a styrene-based thermoplastic, a plasticizer, and a tackifier in a cumulative amount of about 20% by weight.

Further provided herein is an electrochemical cell comprising the anode bilayer composition of the present disclosure. Referring to FIG. 1, The electrochemical cell comprises an anode bilayer of the present disclosure, the anode bilayer comprising a first anode layer 100 and a second anode layer 102; a separator layer 104, and a cathode layer 106. The electrochemical cell may further comprise a cathode current collector 108 and an anode current collector 110.

The cathode layer 106 may include a cathode active material such as (“NMC”) nickel-manganese-cobalt which can be expressed as Li(NiₐCo_{b}Mn_{c})O₂ (0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof. In another embodiment, the cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-Y}Co_{y}O₂, LiCo_{1-Y}Mn_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}CO_{Z}O₄ (0<Z<2), LiCoPO₄, LiFePO₄, CuO, Li(NiₐCo_{b}Al_{c})O₂ (0<a<1, 0<b<1, 0<c<1, a+b+c=1) or a combination thereof. In yet another embodiment, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combinations thereof. In still further embodiments, the cathode active material may comprise elemental sulfur (S). In additional embodiments, the cathode active material may comprise one or more of a fluoride cathode active material such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AIF₃), and zirconium (IV) fluoride (ZrF₄), or combinations thereof.

The cathode layer 106 may further comprise one or more conductive additives. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, VGCF, and carbon nanotubes. In some aspects, the conductive additive may be present in the cathode layer 106 in an amount of about 1% to about 10%.

The cathode layer 106 may further comprise one or more solid electrolytes. The one or more solid electrolyte may comprise an oxide, oxysulfide, sulfide, halide, nitride, or any other solid electrolyte known in the art. In some preferred embodiments, the one or more solid electrolytes may comprise a sulfide solid electrolyte. In some embodiments, the solid electrolyte comprises one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂-LiₓMO_{y} (where x and y are positive numbers, and M is P, Si, Ge, B, Al, Ga or In). In another embodiment, the solid electrolyte may be one or more of a Li₃PS₄, Li₄P₂S₆, Li₇P₃S₁₁, Li₁₀GeP₂S₁₂, Li₁₀SnP₂S₁₂. In a further embodiment, the solid electrolyte may be one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, where 0<y≤2.0, and where the at least one halogen may be one or more of F, Cl, Br, I, and the at least one pseudo-halogen may be one or more of N, NH, NH₂, NO, NO₂, BF₄, BH₄, AlH₄, CN, and SCN. In yet another embodiment, the solid electrolyte be expressed by the formula Li_{8-y-z}P₂S_{9-y-z}X_{y}W_{z} (where “X” and “W” represents at least one halogen elements and or pseudo-halogen and where 0≤y≤1 and 0≤z≤1) and where a halogen may be one or more of F, C, Br, I, and a pseudo-halogen may be one or N, NH, NH₂, NO, NO₂, BF₄, BH₄, AlH₄, CN, and SCN. In some aspects, the solid electrolyte may be present in the cathode layer 106 in an amount of about 5% to about 20%. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(β-Ω)}, where: 0≤β≤1; 0≤Ω≤6; α=6−[(β*4)+(1−β)*3]; X and Y are a halogen such as F, C, Br, I; M is an element with an oxidation state of 4+ such as Ti, Zr, Hf, and Rf; and N is an element an oxidation state of 3+ such as Ga, In, and Tl, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In other embodiments, the cathode layer may include a semi-solid electrolyte, or a liquid electrolyte.

The cathode layer 106 may further comprise one or more of a binder. In some embodiments, the binder may include fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be one or more of a polycondensation polymer such as but not limited to polyurea, polyamide paper, polyimide, polyester, and the like. In other embodiments, the binder may include cellulosic binders such as carboxymethylcellulose (CMC). In yet a further embodiment, the binder may be one or more of a nitrile rubber such as but not limited to acrylonitrile-butadiene rubber (ABR), polystyrene nitrile-butadiene rubber (PS-NBR), and mixtures thereof. In further embodiments, the binder may be one or more of a styrene-based thermoplastic, such as but not limited to styrene-butadiene rubber (SBR), styrene-butadiene-styrene block copolymer (SBS), styrene-isoprene block copolymer (SIS), or styrene-ethylene-butylene-styrene block copolymer (SEBS). In other embodiments, the binder may comprise one or more of styrene-butadiene rubber (SBR), polyvinylidene fluoride (PVdF), carboxymethylcellulose (CMC), or combinations thereof or derivatives thereof.

In some embodiments, the binder may comprise one or more rheology modifying components. In some preferred embodiments, when the binder comprises one or more rheology modifying components, the binder further comprises one or more additional binders or polymers that are not rheology modifying components. In some aspects, the binder may be present in the cathode layer 106 in an amount of about 0% to about 5%.

The separator layer 104 (also referred to herein as the “electrolyte layer”) may include one or more solid electrolytes. The one or more solid electrolytes may comprise an oxide, oxysulfide, sulfide, halide, nitride, or any other solid electrolyte known in the art. In some preferred embodiments, the one or more solid electrolytes may comprise a sulfide solid electrolyte. In some aspects, the one or more sulfide solid electrolyte may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In some embodiments, one or more of the solid electrolyte materials may be Li₃PS₄, Li₄P₂S₆, Li₇P₃S₁₁, Li₁₀GeP₂S₁₂, Li₁₀SnP₂S₁₂. In another embodiment, one or more of the solid electrolyte materials may be Li₆PS₅Cl, Li₆PS₅Br, Li₆PS₅l or expressed by the formula Li_{7-y}PS_{6-y}X_{y}, where “X” represents at least one halogen and/or at least one pseudo-halogen, where 0<y≤2.0, and where the halogen may be one or more of F, Cl, Br, I, and the pseudo-halogen may be one or more of N, NH, NH₂, NO, NO₂, BF₄, BH₄, AlH₄, CN, and SCN. In another embodiment, one or more of the solid electrolyte materials may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, C, Br, I, and the pseudo-halogen may be one or more of N, NH, NH₂, NO, NO₂, BF₄, BH₄, AlH₄, CN, and SCN. Halide solid electrolytes may have the structure Li-M-X, M is a metal element, and X is a halogen. These can be expressed by the generic formula Li_{α}M⁴⁺_{β}N³⁺_{(1-β)}X_{Ω}Y_{(β-Ω)}, where: 0≤β≤1; 0≤Ω≤6; α=6−[(β*4)+(1−β)*3]; X and Y are a halogen such as F, C, Br, I; M is an element with an oxidation state of 4+ such as Ti, Zr, Hf, and Rf; and N is an element an oxidation state of 3+ such as Ga, In, and Tl, Sc, Y, Fe, Ru, Os, Er. Examples of halide electrolytes include Li₂ZrCl₆, Li₃InCl₆, Li_{2.25}Hf_{0.75}Fe_{0.25}Cl₄Br₂.

In other embodiments, the separator layer may include a semi-solid electrolyte, or a liquid electrolyte.

The separator layer 104 may further comprise one or more of a binder. In some embodiments, the binder may include fluororesin containing vinylidene fluoride (VdF), hexafluoropropylene (HFP), tetrafluoroethylene (TFE), and derivatives thereof as structural units. Specific examples thereof may include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer, such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. In a further embodiment, the binder may be one or more of an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), and mixtures thereof. In some embodiments, the binder may comprise one or more rheology modifying components. In some preferred embodiments, when the binder comprises one or more rheology modifying components, the binder further comprises one or more additional binders or polymers that are not rheology modifying components. In some aspects, the binder may be present in the separator layer 104 in an amount of about 0% to about 20% by weight.

In some embodiments, the separator layer 104 may have a thickness of about 10-40 μm. In some aspects, the separator layer 104 may have a thickness of about 10 μm to about 20 μm, about 10 μm to about 30 μm, about 20 μm to about 30 μm, about 20 μm to about 40 μm, or about 30 μm to about 40 μm. In some additional aspects, the separator layer 104 may have a thickness of about 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, or about 40 μm.

The cathode current collector 108 is disposed adjacent to the cathode layer 106, and the anode current collector 110 is disposed adjacent to the first anode layer 100. The cathode current collector 108 and the anode current collector 110 may comprise one or more of copper, nickel, titanium, stainless steel, magnesium, iron, zinc, indium, germanium, silver, platinum, or gold. In some embodiments, the cathode current collector 108 or the anode current collector 110 may have a thickness of about 5 μm to about 10 μm. In preferred embodiments, the cathode current collector 108 comprises aluminum, nickel, and/or steel. In additional preferred embodiments, the anode current collector 110 comprises copper.

The electrochemical cell may be cycled while applying a stack pressure of up to 3000 psi. In some embodiments, the stack pressure may be about 3000 psi or less, about 2500 psi or less, about 2000 psi or less, about 1500 psi or less, about 1000 psi or less, about 750 psi or less, about 500 psi or less, or about 250 psi or less. In an exemplary embodiment, a stack pressure of about 1500 psi or less is applied to the composition. In some additional embodiments, the stack pressure applied to the composition may be from about 100 psi to about 250 psi, about 100 psi to about 500 psi, about 100 psi to about 750 psi, about 100 psi to about 1000 psi, about 100 psi to about 1500 psi, about 100 psi to about 2000 psi, about 100 psi to about 2500 psi, about 100 psi to about 3000 psi about 250 psi to about 3000 psi, about 500 psi to about 3000 psi, about 750 psi to about 3000 psi, about 1000 psi to about 3000 psi, about 1500 psi to about 3000 psi, about 2000 psi to about 3000 psi, about 2500 psi to about 3000 psi, about 250 psi to about 2500 psi, about 750 psi to about 2000 psi, or about 1000 psi to about 2000 psi.

The electrochemical cell may be cycled at a temperature from about 10° C. to about 50° C. In some embodiments, the electrochemical cell may be cycled at a temperature from about 10° C. to about 20° C., about 10° C. to about 30° C., about 10° C. to about 40° C., about 10° C. to about 50° C., about 20° C. to about 30° C., about 20° C. to about 40° C., about 20° C. to about 50° C., about 30° C. to about 40° C., about 30° C. to about 50° C., or about 40° C. to about 50° C. For example, the electrochemical cell may be cycled at a temperature of about 10° C., 15° C., 20° C., 25° C., 30° C., 35° C., 40° C., 45° C., or about 50° C.

In general, when a higher stack pressure is applied during the first cell cycle, the electrochemical cell may have a greater capacity retention as compared to an electrochemical cell having less stack pressure applied during the first cell cycle. Without wishing to be bound by theory, the increased stack pressure improves the contact between particles and layers, lowers resistance, and promotes the formation of vertical cracks. However, if the stack pressure is too high, the cell may short.

In general, the capacity retention of the electrochemical cells of the present disclosure may be higher as compared to electrochemical cells comprising monolayer anodes. Capacity retention is the measure of the capacity of the electrochemical cell after cycling as a percentage of the initial capacity of the electrochemical cell. The capacity retention of the electrochemical cells of the present disclosure may be up to about 99.9%. For example, the capacity retention of the electrochemical cell may be about 99.9%, about 99.5%, about 99%, about 95%, about 90%, about 85%, about 80%, about 99.9% to about 99.5%, about 99.9% to about 95%, about 99.9% to about 90%, about 99.9% to about 85%, about 99.9% to about 80%. Additionally, the capacity retention of the electrochemical cell may be at least about 80%, at least about 85%, at least about 90%, at least about 95%, at least about 99%, at least about 99.5%, or at least about 99.9%. The capacity retention may be at least 80% after about 100 cycles, 200 cycles, 300 cycles, 400 cycles, 500 cycles, 600 cycles, 700 cycles, 800 cycles, or after more than 800 cycles.

Additionally, the discharge capacity of the electrochemical cells of the present disclosure may be stable for a greater number of cycles as compared to an electrochemical cell comprising a monolayer anode. As used herein, a “stable” electrochemical cell is a cell that has a discharge capacity that is 80% or greater than the discharge capacity of the electrochemical cell after the first full cycle. By way of a non-limiting example, an electrochemical cell with a discharge capacity of 100 mAh after the first cycle is considered stable if after 100 cycles the discharge capacity of the cell is 80 mAh or greater. For example, the electrochemical cell may have a stable discharge capacity for at least 100 cycles, at least 150 cycles, at least 200 cycles, at least 250 cycles, at least 300 cycles, at least 400 cycles, at least 500 cycles, at least 600 cycles, at least 700 cycles, or at least 800 cycles.

The electrochemical cell of the present disclosure may have a lower internal resistance as compared to an electrochemical cell comprising a monolayer anode.

When electrochemical cells comprising monolayer anodes are cycled, the anode layer has a tendency to separate from the separator layer due to the expansion and contraction of the anode. In an electrochemical cell of the present disclosure, the anode bilayer does not separate from the separator layer when the cell is cycled at a stack pressure of less than 1500 psi.

Additionally, because of the reduced expansion and contraction of the bilayer anode, the bilayer anode has better surface area contact with the separator layer as compared to an electrochemical cell having a monolayer anode. Thus, there may be less void space present between the bilayer anode and the separator layer as compared to an electrochemical cell having a monolayer anode. The surface area contact with the separator layer may be determined via SEM imaging.

Also provided herein is a method of preparing a bilayer anode for use in a solid electrochemical cell. The method may comprise: a) forming a first anode slurry by mixing an anode active material, optionally at least one solid electrolyte material, at least one binder material, and a solvent; b) forming a second anode layer slurry by: mixing an anode active material, at least one solid electrolyte material, at least one binder material, optionally at least one tackifier, optionally at least one plasticizer, and a solvent; c) casting the first anode layer slurry onto a substrate; d) casting the second anode layer slurry onto the first anode layer slurry; and e) drying the first anode layer slurry and the second anode layer slurry to form the anode bilayer. In some embodiments, there may be an intermediate drying step prior to step d) comprising drying the first layer slurry. In steps a) and b), the components to form the slurry may be mixed in any order or sequence. As a non-limiting example, the anode active material, the at least one solid electrolyte material, and the at least one binder material may be mixed before the solvent is added to form the slurry. Alternatively, as another non-limiting example, each of the anode active material, the at least one solid electrolyte material, and the at least one binder material may be added sequentially to the solvent while it is mixed.

In an alternate embodiment, the method may comprise: a) forming a first anode slurry by mixing an anode active material, optionally at least one solid electrolyte material, at least one binder material, and a solvent; b) forming a second anode layer slurry by: mixing an anode active material, at least one solid electrolyte material, at least one binder material, optionally at least one tackifier, optionally at least one plasticizer, and a solvent; c) casting the first anode layer slurry onto a substrate and drying the first anode layer slurry; and d) casting the second anode layer slurry onto the first anode layer slurry and drying the second anode layer slurry.

In some embodiments, the solvent may be selected from but is not limited to one of the following: aprotic hydrocarbons, esters, ethers or nitriles. In another aspect, the aprotic hydrocarbons may be selected from but are not limited to one of the following: xylenes, toluene, benzene, methyl benzene, hexanes, heptane, octane, alkanes, isoparaffinic hydrocarbons or a combination thereof. In another aspect, the esters may be selected from but are not limited to one of the following: butyl butyrate, isobutyl isobutyrate methyl propionate, ethyl propionate, propyl propionate, butyl propionate, methyl acetate, ethyl acetate, propyl acetate, butyl acetate or a combination thereof. In another aspect, the ethers may be selected from but are not limited to one of the following: diethyl ether, dibutyl ether, benzyl ether or a combination thereof. In another aspect, the nitriles may be selected from but are not limited to one of the following: acetonitrile, propionitrile, butyronitrile, pyrrolidine or a combination thereof. The solvent used to form the first layer slurry may be the same as or different from the solvent used to form the second layer slurry.

After the anode bilayer is dried on the substrate, the anode bilayer may be densified to increase the density of the anode bilayer. Methods of densification are well-known to those having skill in the art. In preferred embodiments, the densification is accomplished by calendering or by pressing, e.g., with a linear press. In some embodiments, the temperature during densification may be about 80° C. to about 140° C. It will be appreciated that the density of the anode layer will depend on the formulation of the anode layer as well as the densification conditions. Without wishing to be bound by theory, increasing the density of the anode bilayer reduces the porosity of the anode bilayer, thereby improving contacts between particles and lowering the resistance of the anode bilayer.

### Exemplary Embodiments

Embodiment 1: An anode composition comprising:
a first anode layer in operable contact with a second anode layer, the first anode layer and second anode layer each comprising:
an anode active material; and a binder,
wherein the second anode layer further comprises a solid electrolyte material, and
wherein the first anode layer optionally comprises a solid electrolyte material.

Embodiment 2: The anode composition of embodiment 1, wherein the anode active material is present in the first layer in an amount of greater than or equal to about 50% by weight of the first layer.

Embodiment 3: The anode composition of embodiment 1 or 2, wherein the anode active material is present in the second anode layer in an amount of about 20% to about 70% by weight of the second anode layer.

Embodiment 4: The anode composition of any one of embodiments 1-3, wherein the anode active material of the first anode layer comprises an inorganic material.

Embodiment 5: The anode composition of embodiment 4, wherein the inorganic material is selected from the group consisting of silicon, silicon alloys, tin, tin alloys, germanium, germanium alloys, and combinations thereof.

Embodiment 6: The anode composition of embodiment 5, wherein the inorganic material is silicon, silicon alloys, or combinations thereof.

Embodiment 7: The anode composition of any one of embodiments 1-6, wherein the first anode layer comprises about 5% or less of a solid electrolyte material.

Embodiment 8: The anode composition of any one of embodiments 1-7, wherein the first anode layer comprises about 1% or less of a solid electrolyte material.

Embodiment 9: The anode composition of any one of embodiments 1-8, wherein the first anode layer does not include a solid electrolyte material.

Embodiment 10: The anode composition of any one of embodiments 1-9, wherein the solid electrolyte material comprises a sulfide-based solid electrolyte material.

Embodiment 11: The anode composition of any one of embodiments 1-10, wherein the binder of the first anode layer is different from the binder in the second anode layer.

Embodiment 12: The anode composition of any one of embodiments 1-11, wherein the binder comprises one or more of styrene-butadiene rubber (SBR), polyvinylidene fluoride (PVdF), carboxymethylcellulose (CMC), or combinations thereof or derivatives thereof.

Embodiment 13: The anode composition of any one of embodiments 1-12, further comprising a current collector in operable contact with the first anode layer.

Embodiment 14: The anode composition of any one of embodiments 1-13, wherein the first anode layer or the second anode layer further comprises a carbon-based conductive additive.

Embodiment 15: The anode composition of claim 14, wherein the carbon-based conductive additive is selected from the group consisting of graphite, graphene, carbon black, carbon nanotubes, carbon nanowires, vapor grown carbon fiber, activated carbon, and combinations thereof.

Embodiment 16: The anode composition of claim 1, wherein the second anode layer further comprises a tackifier.

Embodiment 17: The anode composition of claim 16, wherein the tackifier comprises a hydrocarbon resin.

Embodiment 18: The anode composition of claim 1, wherein the second anode layer further comprises a plasticizer.

Embodiment 19: The anode composition of claim 18, wherein the plasticizer comprises dioctyl phthalate, dibutyl sebecate, mineral oil, or combinations thereof.

Embodiment 20: The anode composition of claim 1, further comprising a third anode layer, the third anode layer comprising
an anode active material;
a binder;
a conductive additive; and
a solid electrolyte material; and
wherein the weight percent amount of anode active material, binder, conductive additive, and/or solid electrolyte material in the third anode layer is different from the amounts in the first anode layer and second anode layer.

Embodiment 21: A method of making the anode composition of claim 1, the method comprising:
a) forming a first anode layer slurry by: mixing an anode active material, optionally at least one solid electrolyte material, at least one binder material, and a solvent;
b) forming a second anode layer slurry by: mixing an anode active material, at least one solid electrolyte material, at least one binder material, and a solvent;
c) casting the first anode layer slurry onto a substrate;
d) casting the second anode layer slurry onto the first anode layer slurry; and
e) drying the first anode layer slurry and the second anode layer slurry to form the anode composition.

Embodiment 22: The method of claim 21, wherein the mixing in step a) comprises mixing an anode active material, at least one solid electrolyte material, and at least one binder material, wherein substantially no solid electrolyte material is included in the combining.

Embodiment 23: The method of claim 21 or 22, wherein the mixing in step a) does not include at least one solid electrolyte material.

Embodiment 24: A method of making the anode composition of claim 1, the method comprising:
a) forming a first anode layer slurry by: mixing an anode active material, optionally at least one solid electrolyte material, at least one binder material, and a solvent;
b) forming a second anode layer slurry by: mixing an anode active material, at least one solid electrolyte material, at least one binder material, optionally at least one plasticizer, optionally at least one tackifier, and a solvent;
c) casting the first anode layer slurry onto a substrate and drying the first anode layer slurry; and
d) casting the second anode layer slurry onto the first anode layer slurry and drying the second anode layer slurry.

Embodiment 25: A composition comprising a solid bilayer anode, the bilayer anode comprising:
a first anode layer, the first anode layer comprising:
   a first anode active material, wherein the first anode active material is present in the first anode layer in an amount of greater than or equal to about 50% by weight of the first anode layer;
   a first binder; and
   a first conductive additive;
a second anode layer, the second anode layer comprising:
   a second anode active material, wherein the second anode active material is present in the second anode layer in an amount of about 20% to about 70% by weight of the second anode layer;
   a second binder;
   a second conductive additive; and
   a solid electrolyte material.

Embodiment 26: The composition of claim 25, wherein the first anode layer comprises substantially no solid electrolyte material.

Embodiment 27: The composition of claim 25, wherein the first anode layer is devoid of a solid electrolyte material.

Embodiment 28: The composition of claim 25, wherein the anode active material is present in the first layer in an amount of greater than or equal to about 50% by weight of the first layer.

Embodiment 29: The composition of claim 25, wherein the anode active material is present in the second anode layer in an amount of about 20% to about 50% by weight of the second anode layer.

Embodiment 30: The composition of claim 25, wherein the anode active material of the first anode layer comprises an inorganic material.

Embodiment 31: The composition of claim 30, wherein the inorganic material is selected from the group consisting of silicon, silicon alloys, tin, tin alloys, germanium, germanium alloys, and combinations thereof.

Embodiment 32: The composition of claim 31, wherein the inorganic material is silicon, silicon alloys, or combinations thereof.

Embodiment 33: The composition of claim 25, wherein the first anode layer comprises about 5% or less of a solid electrolyte material.

Embodiment 34: The composition of claim 25, wherein the first anode layer comprises about 1% or less of a solid electrolyte material.

Embodiment 35: The composition of claim 25, wherein the solid electrolyte material comprises a sulfide-based solid electrolyte material.

Embodiment 36: The composition of claim 25, wherein the binder of the first anode layer is different from the binder in the second anode layer.

Embodiment 37: The composition of claim 25, wherein the binder comprises one or more of styrene-butadiene rubber (SBR), polyvinylidene fluoride (PVdF), carboxymethylcellulose (CMC), or combinations thereof or derivatives thereof.

Embodiment 38: The composition of claim 25, further comprising a current collector in operable contact with the first anode layer.

Embodiment 39: The composition of claim 25, wherein the first anode layer or the second anode layer further comprises a carbon-based conductive additive.

Embodiment 40: The composition of claim 39, wherein the carbon-based conductive additive is selected from the group consisting of graphite, graphene, carbon black, carbon nanotubes, carbon nanowires, vapor grown carbon fiber, activated carbon, and combinations thereof.

Embodiment 41: The composition of claim 25, wherein the second anode layer further comprises a tackifier.

Embodiment 42: The composition of claim 41, wherein the tackifier comprises a hydrocarbon resin.

Embodiment 43: The composition of claim 25, wherein the second anode layer further comprises a plasticizer.

Embodiment 44: The composition of claim 43, wherein the plasticizer comprises dioctyl phthalate, dibutyl sebecate, mineral oil, or combinations thereof.

Embodiment 45: A composition comprising a solid bilayer anode, the bilayer anode comprising:
a first anode layer, the first anode layer comprising:
   a first anode active material in an amount of about 60% or greater by weight of the first anode layer;
   a first solid electrolyte material in an amount from about 20% to about 30% by weight of the first anode layer; and
   a first binder in an amount from about 0% to about 20% by weight of the first anode layer; and
a second anode layer, the second anode layer comprising:
   a second anode active material in an amount from about 20% to about 50% by weight of the second anode layer;
   a second solid electrolyte material in an amount of about 45% or less by weight of the second anode layer; and
   a second binder in an amount of about 10% or less by weight of the second anode layer.

Embodiment 46: An electrochemical cell comprising:
a bilayer anode comprising:
   a first anode layer in operable contact with a second anode layer, the first anode layer and second anode layer each comprising:
      an anode active material; and
      a binder,
   wherein the second anode layer further comprises a solid electrolyte material, and
   wherein the first anode layer optionally comprises a solid electrolyte material;
a separator layer, and
a cathode layer.

Embodiment 47: The electrochemical cell of claim 46, further comprising a first current collector in operable contact with the first anode layer of the bilayer anode.

Embodiment 48: The composition of claim 46, wherein the first anode layer comprises substantially no solid electrolyte material.

Embodiment 49: The composition of claim 46, wherein the first anode layer is devoid of a solid electrolyte material.

Those having skill in the art will appreciate that the above methods for forming anode bilayers may be performed to form anode compositions with three or more layers by repeating the steps described above.

Unless defined otherwise, all technical and scientific terms used herein have the same meaning as commonly understood by those of ordinary skill in the art to which the disclosure belongs. Although any methods and materials similar or equivalent to those described herein can be used in the practice or testing of the subject matter of the present disclosure, preferred methods and materials are described. For the purposes of the present disclosure, the following terms are defined below.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

The term “about” will be understood by persons of ordinary skill in the art and will vary to some extent on the context in which it is used. As used herein when referring to a measurable value such as an amount, a temporal duration, and the like, the term “about” is meant to encompass variations of +10%, including ±5%, 1%, and ±0.1% from the specified value, as such variations are appropriate to perform the disclosed methods.

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open ended term, like “comprising” or “including,” it is understood that direct support should be afforded also to “consisting essentially of” language as well as “consisting of” language as if stated explicitly and vice versa.

### EXAMPLES

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### Example 1: Bilayer Anode Cycling Data—No Tackifier or Plasticizer

Four electrochemical cells were manufactured. Two of the electrochemical cells included a single anode layer, and two of the electrochemical cells contained an anode bilayer of the present disclosure. The separator layers and the cathode layers of each of the four cells were the same. The compositions of the anode layers for the four electrochemical cells are provided in Table 1 below. The styrene-based thermoplastic and the sulfide-based solid-state electrolyte (SSE) were the same for all electrochemical cells. All percentages are weight percentages.

TABLE 1

| Cell | Anode active | | Solid |
|---|---|---|---|
| # | material | Binder | Electrolyte |
| 1 | 50% Si | 7% styrene-based | 43% sulfide-based SSE |
| | | thermoplastic | |
| 2 | 50% Si | 7% styrene-based | 43% sulfide-based SSE |
| | | thermoplastic | |
| 3 | 1^{st} Layer: 60% Si | 1^{st} Layer: | 1^{st} Layer: |
| | 2^{nd} Layer: 30% Si | 7% styrene-based | 33% sulfide-based SSE |
| | | thermoplastic | 2^{nd} Layer: |
| | | 2^{nd} Layer: | 63% sulfide-based SSE |
| | | 7% styrene-based | |
| | | thermoplastic | |
| 4 | 1^{st} Layer: 60% Si | 1^{st} Layer: | 1^{st} Layer: |
| | 2^{nd} Layer: 30% Si | 7% styrene-based | 33% sulfide-based SSE |
| | | thermoplastic | 2^{nd} Layer: |
| | | 2^{nd} Layer: | 63% sulfide-based SSE |
| | | 7% styrene-based | |
| | | thermoplastic | |

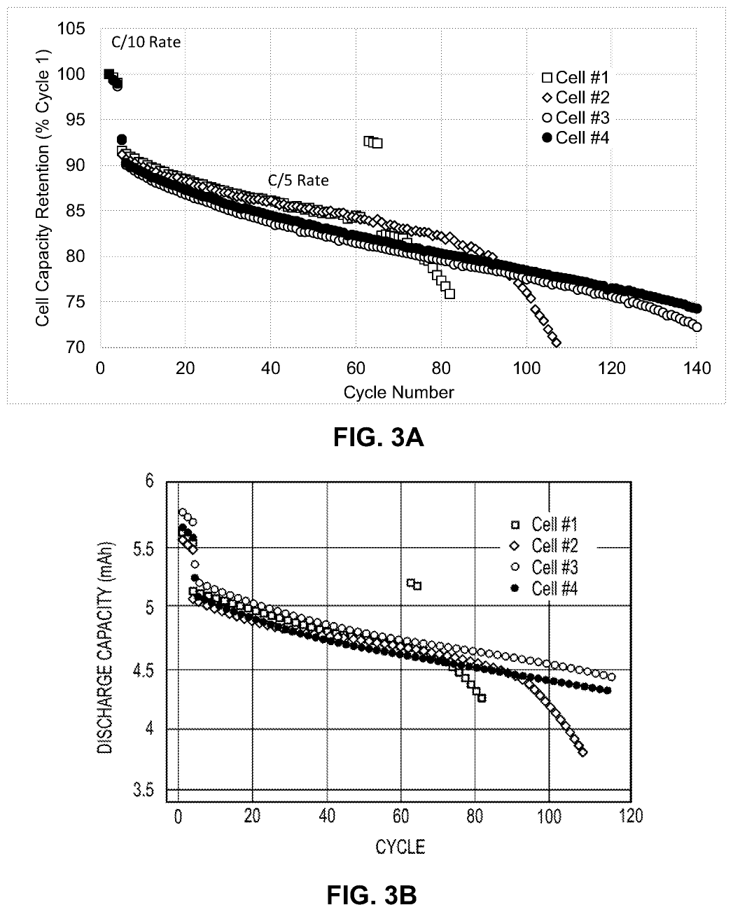

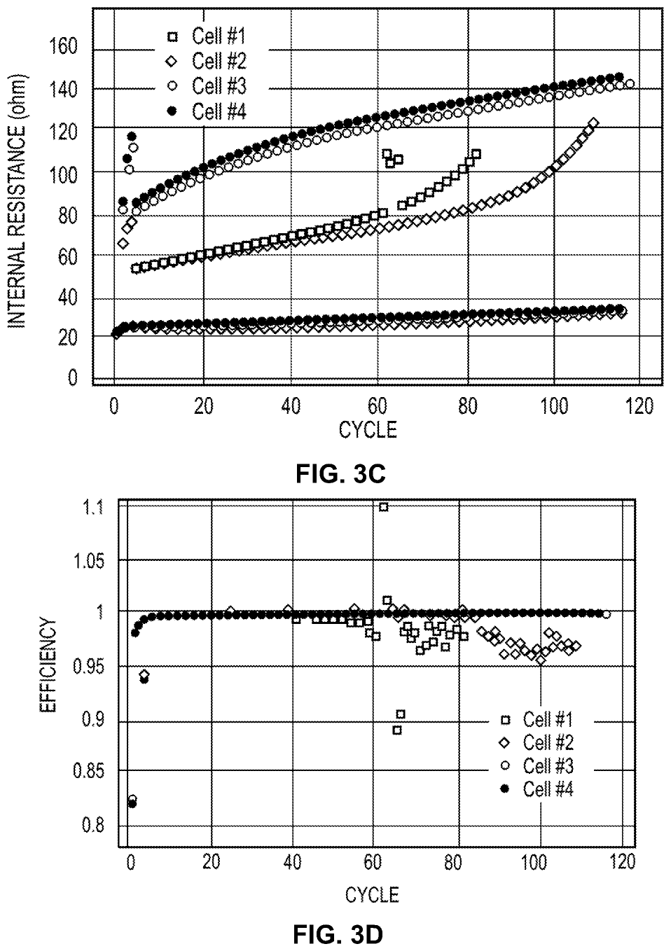

The cells were cycled under a stack pressure of 300 psi at 29° C. Cycling data is shown in FIGS. 3A-3D. Data for cell #1 is shown as open squares (□), data for cell #2 is shown as diamonds (●), data for cell #3 is shown as open circles (∘), and data for cell #4 is shown as solid circles (s). The data showed that the cells having an anode bilayer were stable for greater than 100 cycles.

### Example 2: Bilayer Anode Cycling Data—Cells Including a Tackifier and Plasticizer

Electrochemical cells were made comprising a bilayer anode and monolayer anode. Three electrochemical cells were made that included bilayer anodes, and two electrochemical cells were made that included monolayer anodes. The bilayer anodes included a plasticizer and a tackifier in the second anode layer, and the monolayer anodes also included the plasticizer and tackifier. The plasticizer included mineral oil. The tackifier included a hydrocarbon resin. The styrene-based thermoplastic and the sulfide-based solid-state electrolyte (SSE) were the same for all electrochemical cells. The composition of the anode layer of each cell is provided in Table 2 below. All percentages are weight percentages

TABLE 2

| Cell | Anode active | | Solid |
|---|---|---|---|
| # | material | Binder | Electrolyte |
| 1-3 | 1^{st} layer: 60% Si | 1^{st} Layer: | 1^{st} Layer: |
| | 2^{nd} Layer: 30% Si | 4% styrene-based | 31% sulfide-based |
| | | thermoplastic | SSE + 5% carbon |
| | | 2^{nd} Layer: | 2^{nd} Layer: |
| | | 10% tackifier, | 45% sulfide-based |
| | | 6% styrene-based | SSE + 5% carbon |
| | | thermoplastic, | |
| | | 4% plasticizer) | |
| 4-5 | 50% Si | 5% tackifier, 3% | 35% sulfide-based |
| | | styrene-based | SSE + 5% carbon |
| | | thermoplastic, 2% | |
| | | plastizicer | |

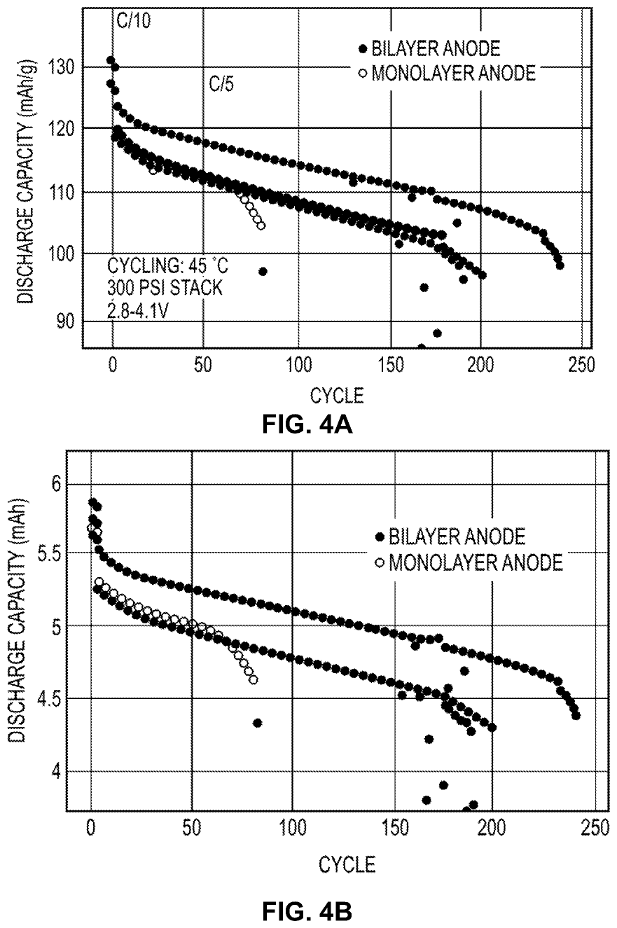

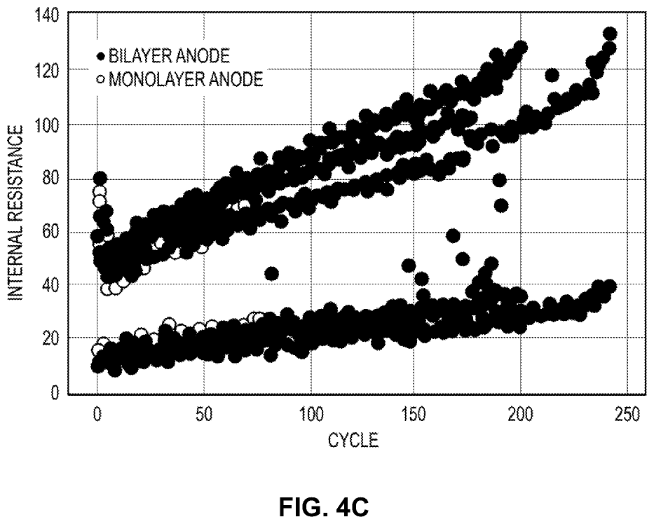

The cycling data for these cells is shown in FIGS. 4A-4C. The bilayer anodes are shown as solid circles (●), and the monolayer anodes are shown as open circles (∘). Cells having a bilayer anode with a high concentration of styrene-based thermoplastic, plasticizer, and tackifier at the interface of the separator had better capacity retention than cells having a monolayer with styrene-based thermoplastic, plasticizer, and tackifier. The data shows that the presence of the tackifier and/or plasticizer alone do not improve the performance of the anode. Rather, the bilayer structure of the anode provides the improved performance of the electrochemical cell.

### Example 3: Bilayer Anode Cycling Data—Effect of Tackifier and Plasticizer in Bilayer Anode

Electrochemical cells were made comprising bilayer anodes. Three cells included a tackifier and a plasticizer in the second anode layer, while three cells did not include a tackifier or plasticizer. The composition of the anode layer of each cell is provided in Table 3 below. The cells were charged over three hours and discharged over three hours for the first three cycles, and then were charged over five hours and discharged over five hours for the remaining cycles. All percentages are by weight percentages.

TABLE 3

| Cell | Anode active | | Solid |
|---|---|---|---|
| # | material | Binder | Electrolyte |
| 1-3 | 1^{st} layer: 60% Si | 1^{st} Layer: | 1^{st} Layer: |
| | 2^{nd} Layer: 30% Si | 4% styrene-based | 31% sulfide-based |
| | | thermoplastic | SSE + 5% carbon |
| | | 2^{nd} Layer: | 2^{nd} Layer: |
| | | 10% tackifier, | 45% sulfide-based |
| | | 6% styrene-based | SSE + 5% carbon |
| | | thermoplastic, | |
| | | 4% plasticizer | |
| 4-6 | 1^{st} layer: 60% Si | 1^{st} Layer: | 1^{st} Layer: |
| | 2^{nd} Layer: 30% Si | 7% styrene-based | 28% sulfide-based |
| | | thermoplastic | SSE + 5% carbon |
| | | 2^{nd} Layer: | 2^{nd} Layer: |
| | | 7% styrene-based | 58% sulfide-based |
| | | thermoplastic | SSE + 5% carbon |

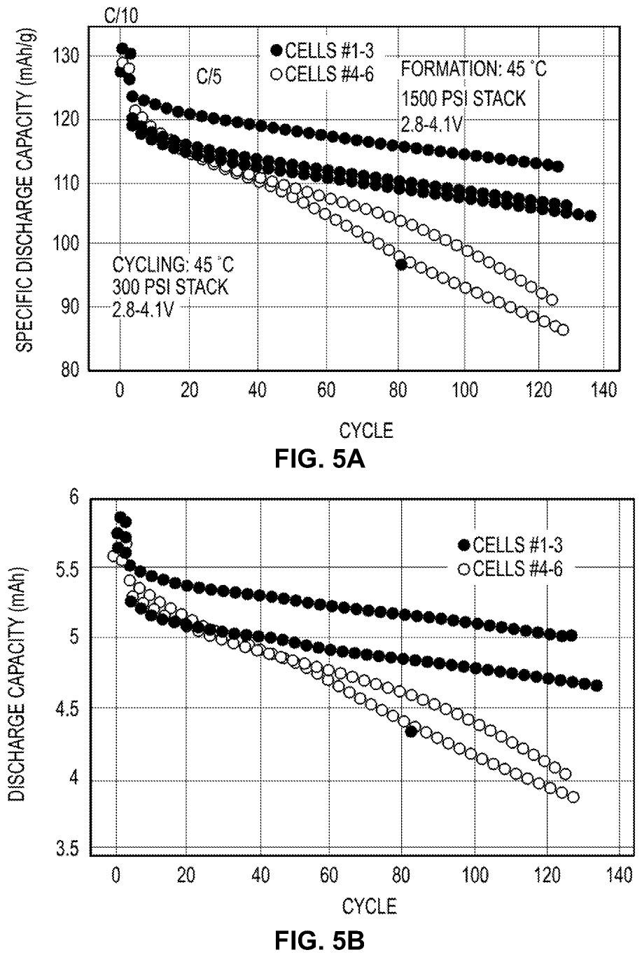

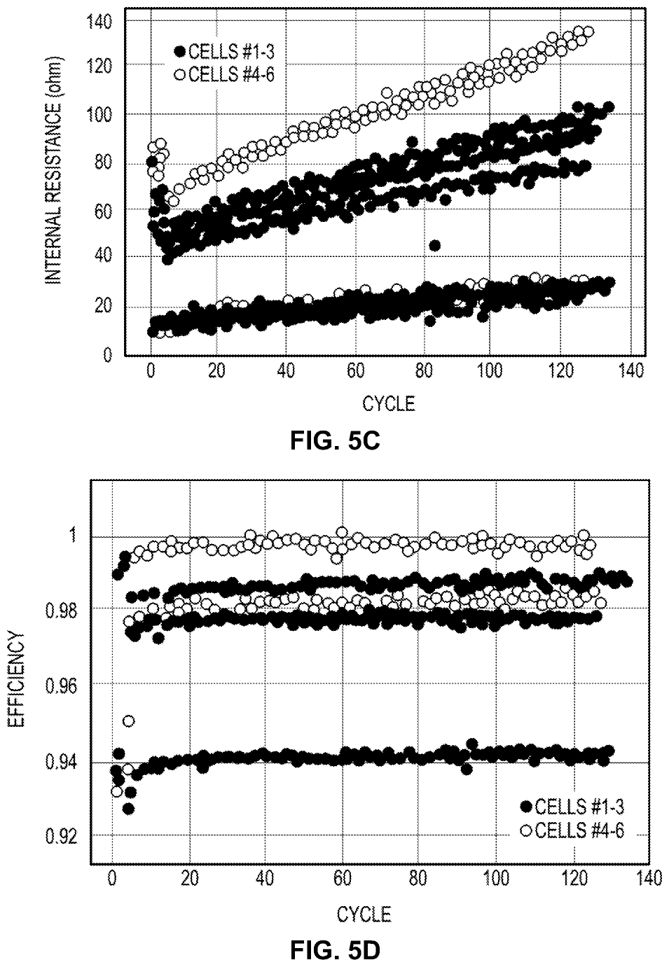

The cycling data for these cells is shown in FIGS. 5A-5D. The bilayer anodes comprising the plasticizer and the tackifier are shown as solid circles (●), while the bilayer anodes that do not have the plasticizer and the tackifier are shown as open circles (∘). The cells having a high concentration of styrene-based thermoplastic, plasticizer, and tackifier at the interface to the separator had better capacity retention as compared to cells containing a bilayer anode with only the styrene-based thermoplastic.

### Example 4: Trilayer Anode Cycling Data

Electrochemical cells were made comprising a trilayer anode of the present disclosure. The composition of the anode layer of each cell is provided in Table 4. All percentages are weight percentages.

TABLE 4

| Cell | Anode active | | Solid | Conductive |
|---|---|---|---|---|
| # | material | Binder | Electrolyte | Additive |
| 1-2 | 1^{st} layer: | 1^{st} Layer: | 1^{st} Layer: | 1^{st} Layer: |
| | 75% Si | 4% styrene-based | 16% SSE | 5% |
| | 2^{nd} Layer: | thermoplastic | 2^{nd} Layer: | 2^{nd} Layer: |
| | 50% Si | 2^{nd} Layer: | 41% SSE | 5% |
| | 3^{rd} Layer: | 4% styrene-based | 3^{rd} Layer: | 3^{rd} Layer: |
| | 25% Si | thermoplastic | 66% SSE | 5% |
| | | 3^{rd} Layer: | | |
| | | 4% styrene-based | | |
| | | thermoplastic | | |
| 3-4 | 50% Si | 4% styrene-based | 41% | 5% |
| | | thermoplastic | | |

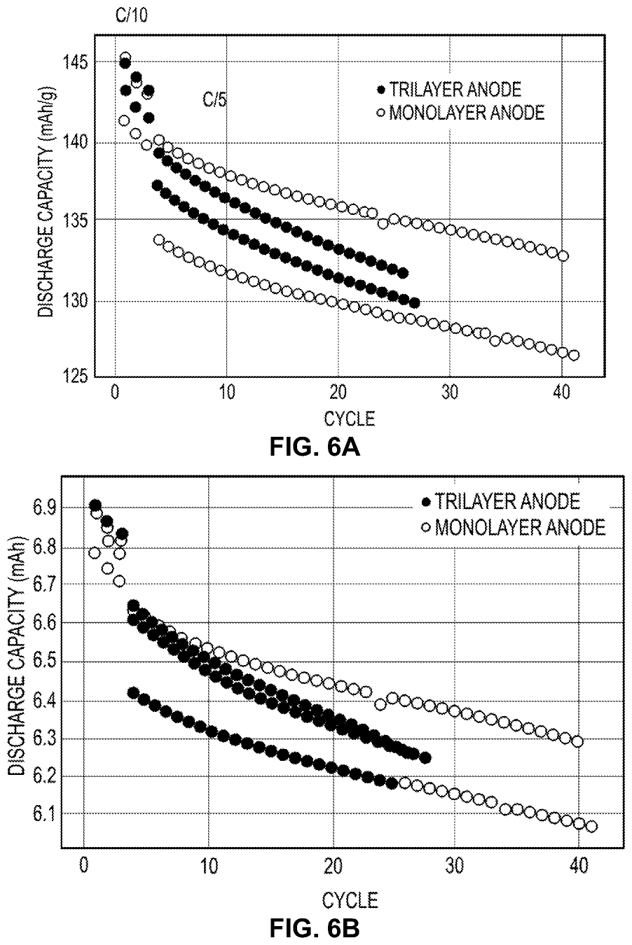

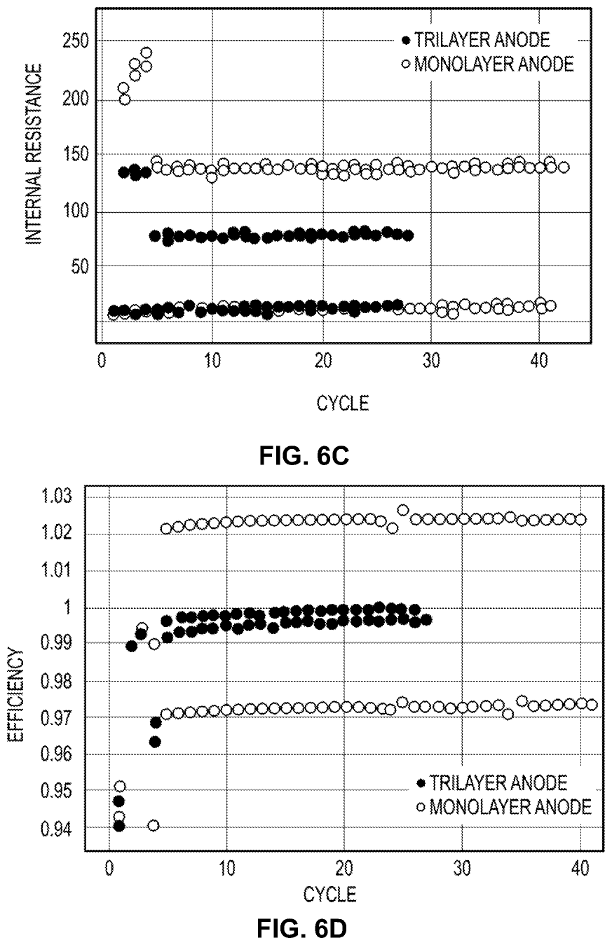

FIGS. 6A-6D show cycling data for each of the cells. Data for cells 1 and 2 are shown as solid circles (●), and data for cells 3 and 4 are shown as open circles (∘). Cells were cycled at 45° C., 300 psi stack pressure, and a voltage window of 2.5-4.2 V. The cells were charged over 10 hours and discharged over 10 hours for the first 3 cycles, and then were charged over 5 hours and discharged over 5 hours for the remaining cycles. The data shows that the discharge capacity faded faster in cells comprising the trilayer anode; however the discharge resistance in the cells comprising the trilayer anode was significantly lower.

### Example 5: Bilayer Anode Cycling Data with Bare Current Collector

Electrochemical cells were made comprising a monolayer anode including 50 wt % silicon and a carbon-coated copper current collector. Electrochemical cells comprising a bilayer anode were also made. The first layer of the bilayer anode (i.e., the layer adjacent to the current collector) included 80 wt % silicon. The second layer of the bilayer anode included 40 wt % silicon. Overall, the proportion of silicon in the bilayer anode was the same as the monolayer anode. These cells had a current collector comprising copper without any coating. The compositions of each of the cells are shown in Table 5.

TABLE 5

| Cell | Anode active | | Solid | Conductive |
|---|---|---|---|---|
| # | material | Binder | Electrolyte | Additive |
| 1-2 | 1^{st} layer: | 1^{st} Layer: | 1^{st} Layer: | 1^{st} Layer: |
| | 80% Si | 10% styrene-based | 0% SSE | 10% |
| | 2^{nd} Layer: | thermoplastic | 2^{nd} Layer: | 2^{nd} Layer: |
| | 40% Si | 2^{nd} Layer: | 50% SSE | 5% |
| | | 5% styrene-based | | |
| | | thermoplastic | | |
| 3-4 | 50% Si | 4% styrene-based | 41% | 5% |
| | | thermoplastic | | |

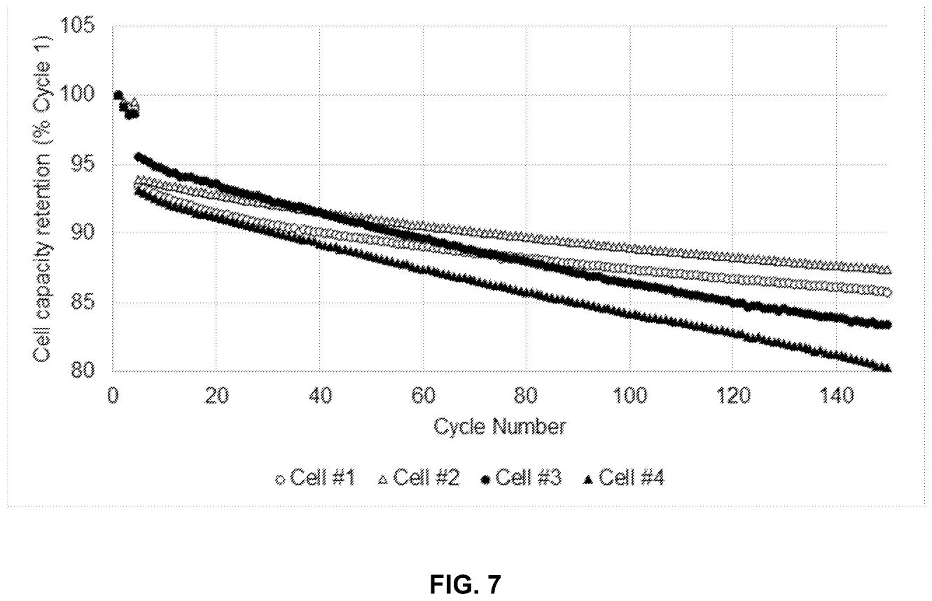

FIG. 7 shows the cycling data for each of the cells. Cells were cycled at 45° C., 300 psi stack pressure, and a voltage window of 2.5-4.2 V. The cells were charged over 10 hours and discharged over 10 hours for the first 3 cycles, and then were charged over 5 hours and discharged over 5 hours for the remaining cycles. As seen in FIG. 7, the cells with the bilayer anode had a more stable cell capacity retention over a longer number of cycles as compared to the cell comprising the monolayer anode.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

What is claimed is:

1. An anode composition comprising:
a first anode layer in operable contact with a second anode layer, the first anode layer and second anode layer each comprising:
an anode active material; and
a binder,
wherein the second anode layer further comprises a solid electrolyte material, and wherein the first anode layer optionally comprises a solid electrolyte material.

2. The anode composition of claim 1, wherein the anode active material is present in the first layer in an amount of greater than or equal to about 50% by weight of the first layer.

3. The anode composition of claim 1, wherein the anode active material is present in the second anode layer in an amount of about 20% to about 50% by weight of the second anode layer.

4. The anode composition of claim 1, wherein the anode active material of the first anode layer comprises an inorganic material.

5. The anode composition of claim 4, wherein the inorganic material is selected from the group consisting of silicon, silicon alloys, tin, tin alloys, germanium, germanium alloys, and combinations thereof.

6. The anode composition of claim 5, wherein the inorganic material is silicon, silicon alloys, or combinations thereof.

7. The anode composition of claim 1, wherein the first anode layer comprises about 5% or less of a solid electrolyte material.

8. The anode composition of claim 1, wherein the first anode layer comprises about 1% or less of a solid electrolyte material.

9. The anode composition of claim 1, wherein the first anode layer does not include a solid electrolyte material.

10. The anode composition of claim 1, wherein the solid electrolyte material comprises a sulfide-based solid electrolyte material.

11. The anode composition of claim 1, wherein the binder of the first anode layer is different from the binder in the second anode layer.

12. The anode composition of claim 1, wherein the binder comprises one or more of styrene-butadiene rubber (SBR), polyvinylidene fluoride (PVdF), carboxymethylcellulose (CMC), or combinations thereof or derivatives thereof.

13. The anode composition of claim 1, further comprising a current collector in operable contact with the first anode layer.

14. The anode composition of claim 1, wherein the first anode layer or the second anode layer further comprises a carbon-based conductive additive.

15. The anode composition of claim 14, wherein the carbon-based conductive additive is selected from the group consisting of graphite, graphene, carbon black, carbon nanotubes, carbon nanowires, vapor grown carbon fiber, activated carbon, and combinations thereof.

16. The anode composition of claim 1, wherein the second anode layer further comprises a tackifier.

17. The anode composition of claim 16, wherein the tackifier comprises a hydrocarbon resin.

18. The anode composition of claim 1, wherein the second anode layer further comprises a plasticizer.

19. The anode composition of claim 18, wherein the plasticizer comprises dioctyl phthalate, dibutyl sebecate, mineral oil, or combinations thereof.

20. The anode composition of claim 1, further comprising a third anode layer, the third anode layer comprising
an anode active material;
a binder;
a conductive additive; and
a solid electrolyte material; and
wherein the weight percent amount of anode active material, binder, conductive additive, and/or solid electrolyte material in the third anode layer is different from the amounts in the first anode layer and second anode layer.

21. A method of making the anode composition of claim 1, the method comprising:
a) forming a first anode layer slurry by: mixing an anode active material, optionally at least one solid electrolyte material, at least one binder material, and a solvent;
b) forming a second anode layer slurry by: mixing an anode active material, at least one solid electrolyte material, at least one binder material, optionally at least one plasticizer, optionally at least one tackifier, and a solvent;
c) casting the first anode layer slurry onto a substrate;
d) casting the second anode layer slurry onto the first anode layer slurry; and
e) drying the first anode layer slurry and the second anode layer slurry to form the anode composition.

22. The method of claim 21, wherein the mixing in step a) comprises mixing an anode active material, at least one solid electrolyte material, and at least one binder material, wherein substantially no solid electrolyte material is included in the combining.

23. The method of claim 21, wherein the mixing in step a) does not include at least one solid electrolyte material.

24. A composition comprising a solid bilayer anode, the bilayer anode comprising:
a first anode layer, the first anode layer comprising:
a first anode active material, wherein the first anode active material is present in the first anode layer in an amount of greater than or equal to about 50% by weight of the first anode layer;
a first binder; and
a first conductive additive;
a second anode layer, the second anode layer comprising:
a second anode active material, wherein the second anode active material is present in the second anode layer in an amount of about 20% to about 50% by weight of the second anode layer;
a second binder;
a second conductive additive; and
a solid electrolyte material.
